(19) United States
(12) Patent Application Publication
(10) Pub. No.: US 2002/0103622 A1
(43) Pub. Date: Aug. 1, 2002

(54) Decision-aid system based on wirelessly-transmitted vehicle crash sensor information

(76) Inventor: John R. Burge, Redondo Beach, CA (US)

Correspondence Address: Eric K. Satermo, Registered Patent Agent, P.O. Box 19099, Irvine, CA, 92633-9099, US

(21) Appl. No.: 09/907,542

(22) Filed: Jul. 16, 2001

Related U.S. Application Data
(60) Provisional application No. 60/218,576, filed on Jul. 17, 2000.
(60) Provisional application No. 60/218,577, filed on Jul. 17, 2000.
(60) Provisional application No. 60/218,578, filed on Jul. 17, 2000.
(60) Provisional application No. 60/218,579, filed on Jul. 17, 2000.
(60) Provisional application No. 60/223,814, filed on Aug. 8, 2000.
(60) Provisional application No. 60/236,999, filed on Sep. 29, 2000.
(60) Provisional application No. 60/253,796, filed on Nov. 29, 2000.

(51) Int. Cl. G21C 17/00; G06F 15/00

(52) U.S. Cl. 702/183

(57) ABSTRACT

A decision-aid system that receives, analyzes, manages and communicates data from vehicle crash sensors for use by trauma system personnel in treating injured occupants from the vehicles which produced the crash sensor data. The system utilizes a computer system that accepts and analyzes vehicle crash data from vehicle communication systems connected to crash sensors that generate data when a vehicle is involved in a crash. Crash sensor data is stored on a central network for remote access by trauma system personnel and others providing response services and medical services to injured vehicle occupants. By gaining access to crash sensor data, analyzed crash sensor data and other information, accurate patient transport, handling and treatment decisions can be made.

### FIELD OF THE INVENTION

This invention relates to medical decision-aid systems generally, and more specifically to decision-aid systems that provide information based on the analysis of vehicle crash sensor data to providers of emergency medical care.

### BACKGROUND—DESCRIPTION OF THE PRIOR ART

The present invention is a decision-aid system that receives, manages, analyzes and communicates wirelessly-transmitted vehicle crash sensor data in order to improve the decision-making ability of trauma systems with respect to the handling of motor vehicle accident victims from the vehicles in which the crash sensor data originated. The term “trauma system” as used herein includes all elements of the emergency response process set in motion when an individual is involved in an automobile accident, including emergency medical systems (EMS) and dispatch systems as they relate to motor vehicle trauma as well as the hospitals, trauma centers and other facilities that handle and treat victims of motor vehicle trauma.

Automobile accidents are a leading cause of death in the United States, killing over 40,000 people each year. While approximately half of those killed will die at the scene of the accident, the other half will be treated by various medical and emergency response professionals that make up modern trauma systems. Motor vehicle-related trauma is usually referred to as “blunt trauma” because most injuries are internal injuries. Vehicle occupants are injured primarily by the extreme forces placed on their bodies when their vehicle rapidly decelerates from a high rate of speed to a low rate of speed, usually in a fraction of a second. It is well known amongst trauma professionals that blunt trauma is a disease of time. The more rapidly that a severely injured occupant receives surgical treatment, the greater their chances of survival. Modern trauma systems attempt to provide this treatment within the first hour after injury, during what is commonly referred to as “The Golden Hour.”

There are at least five distinct activities that must be performed by a trauma system in order for a severely injured vehicle occupant to receive surgical treatment: (1) a 911 dispatcher receives notification of an accident and dispatches an ambulance; (2) the ambulance travels to scene; (3) on-scene triage and treatment is performed by emergency medical personnel; (4) the injured occupant is transported to a treating facility; and (5) the occupant's injuries are diagnosed by physicians at the treating facility. These activities may take a significant amount of time to perform, often exceeding the Golden Hour. The decisions that drive these activities are based on the information available to the trauma system regarding the injuries to the specific occupants involved (“trauma decision-making system”).

The injuries received by a specific occupant will depend upon the forces generated in the collision as well as the areas of the body that absorbed those forces. These may be affected by several factors including: (1) the dynamics of the impact; (2) the crashworthiness of the vehicle; (3) the vehicle safety features; (4) whether the occupant was wearing restraints; (5) the position of the occupant within the vehicle cabin; and (6) characteristics of the occupant such as their size, weight, age and medical condition. Under present trauma decision-making systems, the only available information regarding these factors is usually that gathered at the scene of the accident by emergency responders such as police, fireman, emergency medical technicians (EMT's) and paramedics. As a result, delayed or incorrect decisions caused by a lack of precise information could delay surgical intervention, which may result in loss of life or increased injury.

One problem with present trauma decision-making systems is that there is little data available to 911 dispatchers that allow them to determine the severity of occupant injuries and therefore guide them in making dispatch decisions. Different ambulances may be equipped with different equipment. Some ambulances are equipped to provide Advanced Life Support and are staffed with paramedics, whereas others may be Basic Life Support ambulances staffed by Emergency Medical Technicians with minimal life-support training. In addition, air ambulances may be able to transport a severely injured patient to a facility much more quickly than a ground ambulance. Under the present system, 911 dispatchers do not usually have information about the likely survival time of the injured occupants, what level of life support expertise is needed to get them to a facility alive, or what level of trauma facility or surgical specialties will be needed. As a result, they may base dispatch decisions solely on the current availability of ambulances to respond to the scene without regard to the level of life-support care that may be needed.

Another problem with present trauma decision-making systems is that emergency responders have little advance knowledge of what they may find at an accident scene. They generally do not know how many injured occupants may be present, or what type of injuries they can expect. They may not have information suggesting whether vehicle extrication may be required, or whether they will face hazards from potential vehicle fires, fuel leaks or explosions. They may need to call for backup or air transport, and may not know what their destination facility will be or who will ultimately be directing the trauma team. Simple decisions such as what type of equipment to carry from the ambulance to the damaged vehicle could be impacted by the level of knowledge that an emergency responder has regarding the crash event.

Another problem with present trauma decision-making systems relates to “mechanism of injury” data. The term “mechanism of injury” is used to describe information about the movements of the occupant within the vehicle, including the forces sustained by the various body parts of the occupant. Given the difficulty in diagnosing blunt trauma injuries, which are often internal, mechanism of injury information is very important in determining the likely injuries and their severity. As a result, mechanism of injury data is often relied upon by emergency response and medical professionals to make decisions about pre-transport treatment, facility selection, trauma team activation and diagnostic procedures. Under present trauma decision-making systems, mechanism of injury data may only be estimated by emergency responders based on their visual observations about the crashed vehicles and their occupants.

Another problem with present trauma decision-making systems is the quality of data used to select the destination facility. Most trauma centers have specific admission criteria that is usually based on the extent of injury perceived by the emergency responders. However, it is very difficult for an emergency responder to diagnose an internal brain, abdominal or pelvic injury in the field that may not exhibit external signs. Restrained occupants may not strike anything within the vehicle during the crash except for safety restraint systems, yet suffer severe injuries resulting purely from rapid deceleration. As a result, there is a significant population of severely injured patients who will be initially transported to either a hospital emergency department or a lower-level trauma center. The severity of their injuries will likely be discovered at those facilities, where they either will attempt treatment or transfer to a specialized trauma facility depending upon the stability of the patient. This costs precious time that may be needed in order to save the life of the patient.

Another problem with present trauma decision-making systems is that existing mechanism of injury data is not accurate enough to reliably predict trauma team resources which need to be activated. Specific criteria must usually be met by a patient in order to activate a trauma team, or to activate specific trauma team members such as a neurosurgeon. If a patient fails to initially meet this criteria but has a hidden severe head or abdominal injury, key trauma personnel may not be available in a timely manner in order to treat them. Additionally, diagnostic resources (X-ray, CT-scan) may also need to be coordinated to be sure they are available, and insure that no delays take place during patient handling. CT scans and X-rays are critical diagnostic tools for injury diagnosis. CT scanners are extremely expensive, and may be located several floors and hundreds of yards away from the patient location. When dealing with a multiply injured patient that has thoracic, abdominal, pelvic or other injuries causing substantial hemorrhage, lifesaving surgery may have to be postponed because a definitive CT scan diagnosis cannot be obtained.

Another problem with trauma decision-making systems is that surgeons are forced to make critical diagnosis and treatment decisions based on very little information. While the emergency responders to the accident scene may be able to provide some mechanism of injury information, this information is often unreliable. Deteriorating patient condition often forces the surgeon to stop the diagnostic process before a definitive diagnosis can be made, and make guesses about likely injuries so the patient does not die while being diagnosed. The surgeon often has no choice but to rely on obtained mechanism of injury information obtained from emergency responders.

Another problem with trauma decision-making systems is that trauma surgeons are often faced with daunting task of treating severely and multiply injured patients, under tremendous time pressure, and with little information about how they were injured. As a result, some injuries will necessarily be missed that, if discovered earlier, may have saved a life. Brain, abdominal and pelvic injuries represent three areas that are particularly hard to diagnose.

The prior art describes attempts to overcome some of the above drawbacks. For example, the systems disclosed by Shaibani (U.S. Pat. No. 5,586,024) and Dormond, et al. (U.S. Pat. No. 4,839,822) disclose computer systems for diagnosing trauma injuries in which system users input information about the victim and the accident circumstances, and the computer system provides a possible injury list or suggested treatments. These systems are designed to process the existing information available to trauma surgeons through the trauma system, and do not disclose the capture and analysis of vehicle sensor and other crash-related information. Nor do they provide a delivery system for the various entities in the trauma system as disclosed by the present invention. Thus trauma decision-aid systems in the prior art do not solve many of the problems that currently exist in trauma decision-making systems.

There is therefore a need for a trauma decision-aid system that provides information from sensors within the crash-involved vehicles to trauma system personnel. The present invention is designed to utilize detailed vehicle crash sensor information, transmitted through vehicle wireless communication systems such as the General Motors OnStar system or the Mercedes Benz Tele-Aid system, in providing a decision-aid system for trauma system personnel responding to motor vehicle accidents. The present invention provides a decision-aid system for trauma system personnel that involves analyzing this information and delivering it to various participants in the trauma system, providing superior information upon which to determine crash severity and predict potential injuries in order to assist emergency response personnel in response, transport, diagnosis and treatment of injured vehicle occupants.

### SUMMARY OF THE INVENTION

A decision aid system is disclosed for (1) receiving on-board sensor data wirelessly transmitted from crash-involved vehicles, (2) analyzing this data and (3) delivering the results to data users, notably emergency medical personnel. This system enables trauma system personnel to make accurate patient-handling decisions by gaining access to crash sensor data obtained directly from the vehicles involved in the accidents to which they are responding.

In general, a vehicle is shown as including an on-board communications system connected to crash sensors that generate data when a vehicle is involved in a crash. The crash sensors are preferably located within an occupant restraint system, and include vehicle movement sensors, occupant sensors and system sensors. The vehicle owner or driver preferably subscribers to a vehicle communication service, and authorizes the transmission of crash sensor data generated by these sensors through a wireless network to the operations center rendering location-based services. At the time crash sensor data is received, the operations center forwards the data to a Crash Data Delivery and Processing System (Crash Data D&PS) along with any stored subscriber data about the driver, vehicle and occupants. The Crash Data D&PS is the heart of the decision-aid system, and includes computer systems for managing, analyzing and presenting crash event data. Data users that seek to use the decision-aid system, including medical response personnel in the field, can access crash event data through landline and wireless networks.

Objects of the present invention include:

A decision-aid system that manages crash event data for subscribers to a vehicle communication service

A decision-aid system that enables subscribers of vehicle communication services to authorize the capture and transmission of crash sensor data

A decision-aid system that enables crash sensor data to be correlated with subscriber data stored by the provider of a vehicle communication service

A decision-aid system that uses the sensors contained within a safety restraint control system to determine when to transmit crash sensor data to a remote location

A decision-aid system that predicts occupant injury based on crash sensor data

A decision-aid system that uses data generated by occupant sensors to analyze potential occupant injuries

A decision-aid system that bases accident severity predictions on predictions of injury based on analysis of crash sensor data

A decision-aid system that uses time-based criteria for altering data access security levels

A decision-aid system that notifies trauma personnel about crash events that are relevant to their response obligations

A decision-aid system that enables data to be manually inserted into crash event records where other trauma personnel can access the data

A decision-aid system that analyzes crash sensor data against a database of other crash sensor data

A decision-aid system that analyzes crash sensor data against a database of historical injury records

A decision-aid system that analyzes crash sensor data using vehicle crashworthiness data specific to the crash-involved vehicle

A decision-aid system that uses a rules-based expert system to analyze crash sensor data

A decision-aid system that uses a case-based reasoning system to analyze crash sensor data

A decision-aid system that notifies trauma personnel about the availability of crash event data based on geographic data about the crash event and jurisdiction of the trauma personnel

A decision-aid system that enables trauma system personnel to access crash event data using any device commonly used to access the internet, including portable wireless access devices.

A decision-aid system that enables trauma system personnel to configure the characteristics of crash event data displayed to them

A decision-aid system that configures the presentation of crash event data according to the type of device used to access the data

A decision-aid system that enables trauma system personnel to configure the automatic sending of alert messages to wireless devices, computers, telephones and other communication systems used by trauma system personnel

A decision-aid system that provides for collaboration between trauma system personnel and crash data experts

A decision-aid system that provides for communication between injured vehicle occupants and crash data experts that can provide medical assistance and capture medical information

A decision-aid system that notifies trauma system personnel that decision-aid information is available for a particular crash event

A decision-aid system that provides for crash event data to be used in determining the resources that should be dispatched to an accident scene

A decision-aid system that provides for crash event data to be used in the coordination of facility resources for responding to injured trauma patients

A decision-aid system that provides for crash event data to be used to dispatch a surgeon to an accident scene

A decision-aid system that provides for crash event data to be used in authorizing reimbursement for medical care costs incurred based on the use of crash event data

Further objects, advantages and novel features of the present invention will become apparent from the following detailed description of the invention when considered in conjunction with the accompanying drawings.

### DRAWINGS AND FIGURES

FIG. 1 is an overview diagram of the system.

FIG. 2 is an overview diagram of a control center, showing communication with communication system subscribers.

FIG. 3 is a schematic block diagram of an on-board data system

FIG. 4 is a schematic block diagram of a safety restraint control system connected to an on-board data system.

FIG. 5 is an overview diagram of the system showing connection with various access devices.

FIG. 6 shows an exemplary user interface for the system.

FIG. 7a is a schematic block diagram of a crash data management system.

FIG. 7b is a bock diagram showing the different security levels for the crash event databases.

FIG. 7c is an exemplary archived crash event record.

FIG. 7d is an exemplary active crash event record.

FIG. 7e is a flowchart illustrating a process for determining a critical time period.

FIG. 8a is a schematic block diagram of a crash data analysis system.

FIG. 8b is a flowchart illustrating a process for generating a crash event report.

FIG. 8c shows an exemplary crash event report.

FIG. 8d is a flowchart illustrating a process for receiving an injury frequency report.

FIG. 8e is an overview diagram of the legacy data correlation attributes that may be used by a crash data expert to analyze crash event data

FIG. 8f is an exemplary expert system for analyzing crash event data

FIG. 9a is a schematic diagram of a crash data presentation system

FIG. 10a is a schematic diagram of crash event report push sub-system

FIG. 10b is an exemplary trauma facility contact database

FIG. 10c is an exemplary EMR agency contact database

FIG. 11 is an exemplary input screen for configuring delivery of crash event data

FIG. 12 is a schematic diagram of an exemplary collaboration mechanism

FIG. 13 shows an exemplary geographic configuration interface

FIG. 14a is an exemplary primary event table

FIG. 14b is an illustration of use of a primary event table

FIG. 14c shows an exemplary electronic map display system

FIG. 14d shows an illustration of an electronic map display

FIG. 15 is an exemplary mechanics table

FIG. 16 is an exemplary occupant mechanics table

FIG. 17 shows an exemplary vehicle safety data table and selected input data sources

FIG. 18a shows an exemplary occupant information table and an exemplary input source

FIG. 18b shows a passenger excerpt from an occupant information table

FIG. 20 shows an exemplary analysis data table and selected input sources

FIG. 20a illustrates an exemplary input screen for the input of manual input data

FIG. 20b is an overview diagram showing access to the Crash Data D & PS by several types of data users

FIG. 21 is an overview diagram showing a crash data expert providing medical advice to an injured communication systems subscriber

FIG. 22 is a schematic diagram of an on-board data system with audio input and output devices

FIG. 23 shows exemplary visual notification devices

FIG. 24a is a flowchart illustrating a process for delivering crash event reports.

FIG. 24b is a continuation of a flowchart illustrating a process for delivering crash event reports.

FIG. 25 is a flowchart illustrating a process for evaluating the resources to dispatch to a crash scene using crash event data.

FIG. 26 is a flowchart illustrating a process for coordinating facility resources using crash event data.

FIG. 27a is a flowchart illustrating a more detailed process for determining resources to dispatch to a crash scene using crash event data.

FIG. 27b is continuation of a flowchart illustrating a more detailed process for determining resources to dispatch to a crash scene using crash event data.

FIG. 28 is a flowchart illustrating a process for enhancing a trauma diagnosis protocol using crash event data.

FIG. 29 is a flowchart illustrating a process for administering remote treatment to a crash victim using crash event data.

FIG. 30 is a flowchart illustrating a process for determining the survival probability of a crash victim using crash event data.

FIG. 31 is a flowchart illustrating a process for obtaining consumer authorization to transmit and display crash event data.

FIG. 32 is a flowchart illustrating a process for obtaining consumer authorization for use of crash event data by an automobile manufacturer.

FIG. 33 is a flowchart illustrating a process for authorizing reimbursement of medical costs using crash event data.

FIG. 34 is a flowchart illustrating a second process for authorizing reimbursement of medical costs using crash event data.

### DETAILED DESCRIPTION OF THE INVENTION

Overall System Structure

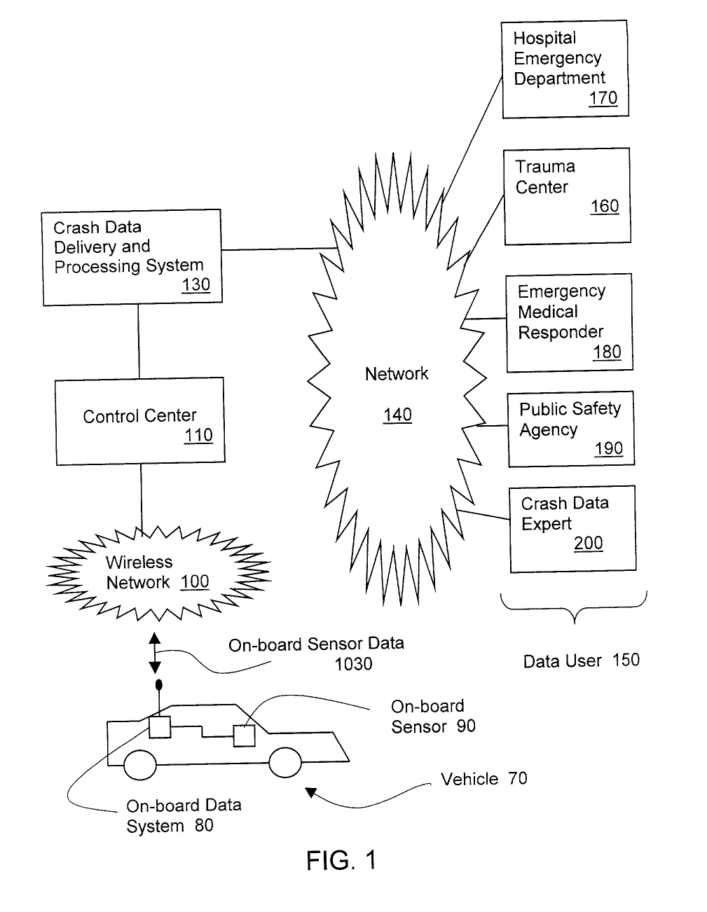

FIG. 1 shows an overview of the system, including a Vehicle 70. As shown in FIG. 1, On-board Sensors 90 located in Vehicle 70 capture On-Board Sensor Data 1030 when Vehicle 70 is involved in a vehicle crash (“crash event”), such as striking another vehicle, striking an object or rolling over. Most new vehicles today have multiple sensors that capture detailed information during a crash event. On-board Sensors 90 can include a variety of sensors, including acceleration sensors (“accelerometers”) that are part of most modern airbag systems. These sensors are capable of capturing detailed information about the acceleration change of the vehicle during a crash event, information that can usually be measured in millisecond or smaller increments.

After a crash occurs, the On-Board Sensor Data 1030 can be transferred to an On-board Data System 80, here shown as a passenger vehicle voice and data communications system such as an OnStar or Tele-Aid system. The On-Board Data System 80 can then wirelessly transmit the On-Board Sensor Data 1030 through a Wireless Network 100. The Wireless Network 100 could be any wireless network, including a cellular telephone network, paging network, satellite communications network, local radio network or other wireless network commonly used as a communication system for wireless data and/or voice.

After being transmitted through Wireless Network 100, the On-Board Sensor Data 1030 is received by a Control Center 110 in a remote location. The Control Center 110 may be any operations center configured to receive data from On-Board Data System 80, including a provider of subscription-based emergency services to vehicle communication system subscribers (such as a General Motors OnStar service), a provider of messaging or location-tracking services to commercial vehicles, or a Public Safety Answering Point (PSAP). After receiving the On-Board Sensor Data 1030, the control center 110 transfers the On-Board Sensor Data 1030 to a Crash Data Delivery and Processing System 130 (Crash Data D&PS). The Control Center 110 and Crash Data D&PS 130 may be connected by a local network if located in the same facility, or may be connected by the internet or other wide area network if located in different geographic areas.

The Crash Data D&PS 130 is configured to receive On-Board Sensor Data 1030, analyze it, and deliver the results to various Data Users 150 that may need the data in order to perform medical or public safety functions. The Crash Data D&PS 130 may be comprised of one or more computers configured to store and process incoming crash event data obtained from vehicle On-board Sensors 90 as well as from other data input sources. Crash event data may also include subscriber data obtained from the Subscriber Database 210 at Control Center 110.

The Crash Data D&PS 130 is preferably located within a secure structure designed to withstand power outages and natural disasters. The Crash Data D&PS 130 receives the On-Board Sensor Data 1030, and performs functions such as interpreting the data, analyzing the data to predict potential occupant injury, and calculating crash event severity. The Crash Data D&PS 130 is connected to a Network 140 which allows access to crash event data, including the analysis of crash event data. Crash event data may be accessed and analyzed by Data Users 150, including Data Experts 200, Hospital Emergency Departments 170, Trauma Centers 160, Emergency Medical Responders 180 and Public Safety Agencies 190.

Crash Data Experts 200 preferably include individuals trained in the interpretation of On-board Sensor Data 1030, and may be skilled in fields such as crash sensor data interpretation, biomechanics, blunt trauma diagnosis and treatment, vehicle crash performance, accident reconstruction or other fields which give them particular expertise in understanding the significance of Onboard Sensor Data 1030. Crash Data Experts 200 are preferably located at or near the site of the Crash Data D&PS 130, and may access the Crash Data D&PS 130 through a high speed Local Area Network (LAN) or other network access system. Crash Data Experts 200 may provide assistance to other Data Users 150, such as data interpretation, analysis, recommendations regarding data reliability, as well as interpretation and analysis of the results of processing of On-board Sensor Data 1030 by the Crash Data D&PS 130. This assistance may be provided in a written or electronic report form, an oral report, direct voice or data communication or any other reliable means of communication.

The Network 140 preferably includes connection to the internet, or other wide area network which allows direct access by Data Users 150 located in different geographic areas, including Crash Data Experts 200 which may be located remotely. Direct access by Hospital Emergency Departments 170, Trauma Centers 160, Emergency Medical Responders 180 and Public Safety Agencies 190 is desired to allow full use of the interactive features of the system by remote Data Users 150, including: (1) the ability to supplement crash event records with additional data; (2) the ability to directly interact with the Crash Data D&PS 130 without the intervention of a Crash Data Expert 200; (3) the ability to analyze the operational characteristics of the Crash Data D&PS 130; (4) the ability to search, query and analyze records stored in the Crash Data D&PS 130; (5) the ability to view models and simulations of vehicle and occupant movements; (6) the ability to selectively run software applications made available through the Crash Data D&PS 130 for processing of On-board Sensor Data 1030.

Trauma Centers 160 include regional trauma centers and medical facilities that maintain special resources and procedures for the emergency medical treatment of trauma victims beyond that ordinarily provided by basic hospitals. Emergency Medical Responders 180 include Emergency Medical Technicians, ambulance services, paramedics, fireman and other public and private responders commonly dispatched to motor vehicle accident scenes such as police. Other Data Users 150 may include government agencies, Universities, research organizations and other entities and individuals who may be interested in study and analysis of data stored in the Crash Data D&PS 130.

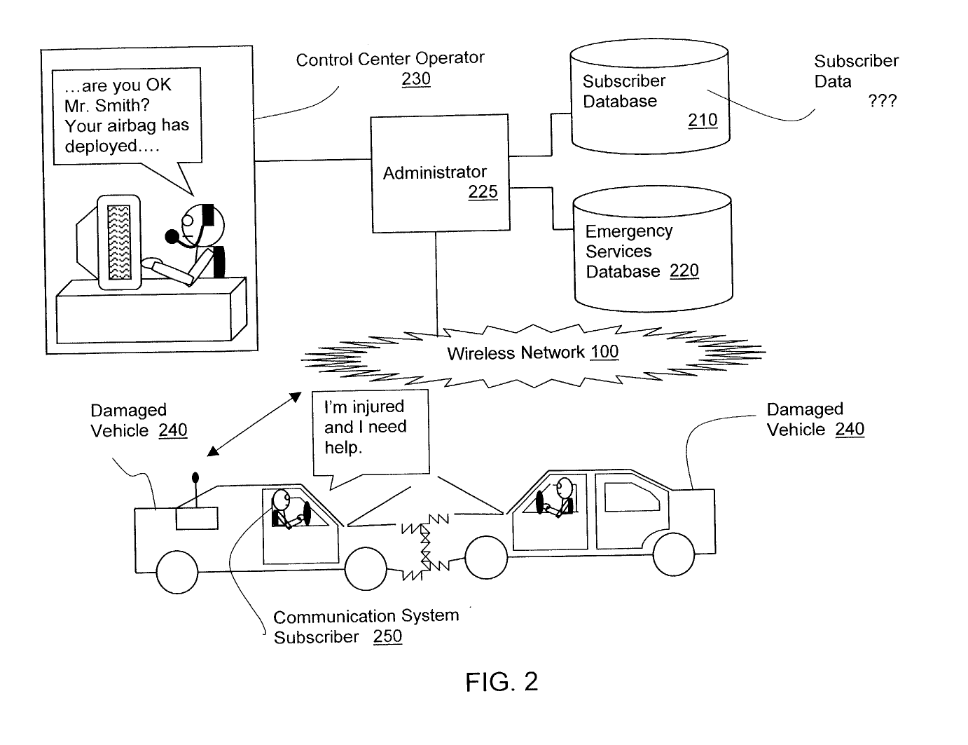

In operation, subscriber data pertinent to a crash event may be transferred from the Control Center 110 to the Crash Data D&PS 130. This subscriber data preferably includes any data stored or processed at the Control Center 110 regarding the vehicle, vehicle occupants, vehicle location or other data regarding the crash event that may affect emergency response decisions. As shown in FIG. 2, vehicle communication systems generally contain a Subscriber Database 210 and Emergency Services Database 220. The Subscriber Database 210 contains subscriber data regarding the vehicle and vehicle occupants, and is usually a relational database stored in a computer. Examples of subscriber data stored in the subscriber database 210 may include:

Personal data

Driver name

Phone number

Address

Date of birth

Social security number

Vehicle data

Vehicle make and model

Vehicle year

VIN

Vehicle color

Emergency Contact data

Physician name

Physician phone number

Emergency contact name

Emergency contact phone number

Medical data

Medical history

Medication allergies

Insurance provider

Baseline EKG

An example of a Communication System Subscriber 250 would be an individual that subscribes to the OnStar System from General Motors or the Tele-Aid System from Mercedes Benz. A Communication System Subscriber 250 may purchase a Communication-enabled Vehicle 70 equipped with an On-board Data System, or may have an On-board Data System installed post-purchase. The Communication System Subscriber 250 generally subscribes to a fee-based service that allows wireless communication between Control Center Operators 230 and Communication System Subscribers 250 through a Wireless Network 100. Services rendered often include stolen vehicle tracking, 911 assistance, driving directions and assistance with emergency roadside service. FIG. 2 shows a Control Center Operator 230 communicating with a Communication System Subscriber 250 located in a Damaged Vehicle 240. Other types of vehicle communication systems may store different type of data, and provide different services.

FIG. 2 also shows an Emergency Services Database 220 which contains contact information about emergency services, and may store geographically-coded information about Public Safety Answering Point (PSAP) jurisdictional boundaries. PSAPs are agencies which handle incoming 911 calls and assist with the dispatch of emergency assistance. The Emergency Services Database 220 allows the control center to utilize location information obtained from the vehicle to contact the appropriate PSAP for the jurisdiction in which the vehicle is located, and thereby provide proper 911 assistance and dispatch services. Data transferred from the Control Center 110 to the Crash Data D&PS 130 may also include data regarding communications between Control Center Operators 230 and public safety agencies contacted in regard to the crash event, as well as the identity, location and contact information for these public safety agencies.

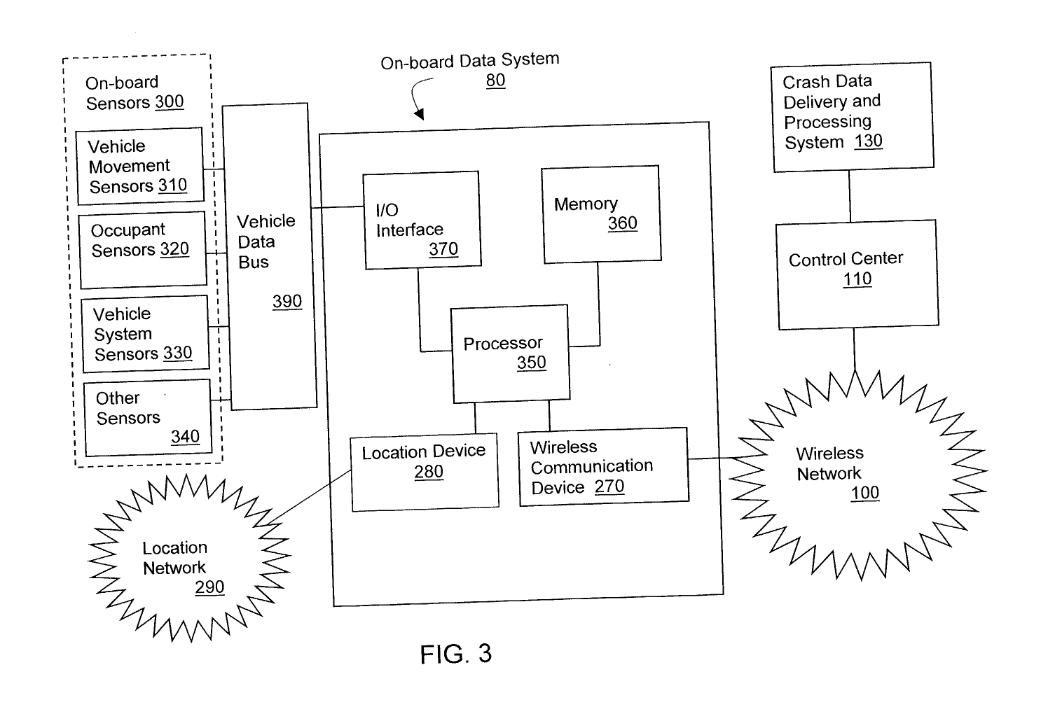

FIG. 3 shows a vehicle level block diagram of an On-board Data System 80 exemplary of a passenger vehicle communications system. On-board Sensors 300 which may provide data to the On-board Data System 80 may be any type of vehicle sensors capable of providing information about a motor vehicle crash, and include sensor types such as Vehicle Movement Sensors 310, Occupant Sensors 320, Vehicle System Sensors 330 and Other Sensors 340. These On-board Sensors 300 may include:

Vehicle Movement Sensors 310

Longitudinal Delta V

Lateral Delta V

Vertical Delta V

Longitudinal Crash Pulse

Lateral Crash Pulse

Vertical Crash Pulse

Vehicle Direction

Vehicle Rotation

Principle Direction of Force

Rollover

Roll Angle

Yaw Rate

Occupant Sensors 320

Air Bag Status

Air Bag On/Off Switch

Air Bag Inflation Time

Time from Impact to Air Bag Deployment

Belt Use

Belt Spool-out

Seat Position

Occupant Presence

Occupant Weight

Occupant Proximity

Occupant Motion

Steering Wheel Angle

Steering Wheel Tilt Position

Steering Wheel Rate

Occupant Camera

Occupant Video Camera

Occupant Audio

Vehicle System Sensors 330

Vehicle Speed

Engine Speed

Wheel Speed

Brake Use

Throttle Position

Traction Control

Traction Coefficient

Advanced Suspension Measurements

Stability Control

Collision Warning

Lane Departure

Automatic Collision Notification

Battery Voltage

Fuel Level

Lamp Status

Windshield Wiper Status

Turn Signal Operation

Active Diagnostic Codes

Other Sensors 340

Environment

Cabin Fire

Cabin Fumes

On-board Sensors 300 as defined herein specifically exclude airbag indictor sensors that are currently transmitted by some existing On-board Data Systems 80 and that notify a Control Center 110 that an airbag has deployed. Additional sensors developed in the future which provide information about motor vehicle crash events should be considered as falling within the scope of the present invention. On-board Sensors 300 may be connected to a Vehicle Data Bus 390, shown in FIG. 3 connected to an On-board Data System 80, or may connect directly to the On-board Data System 80.

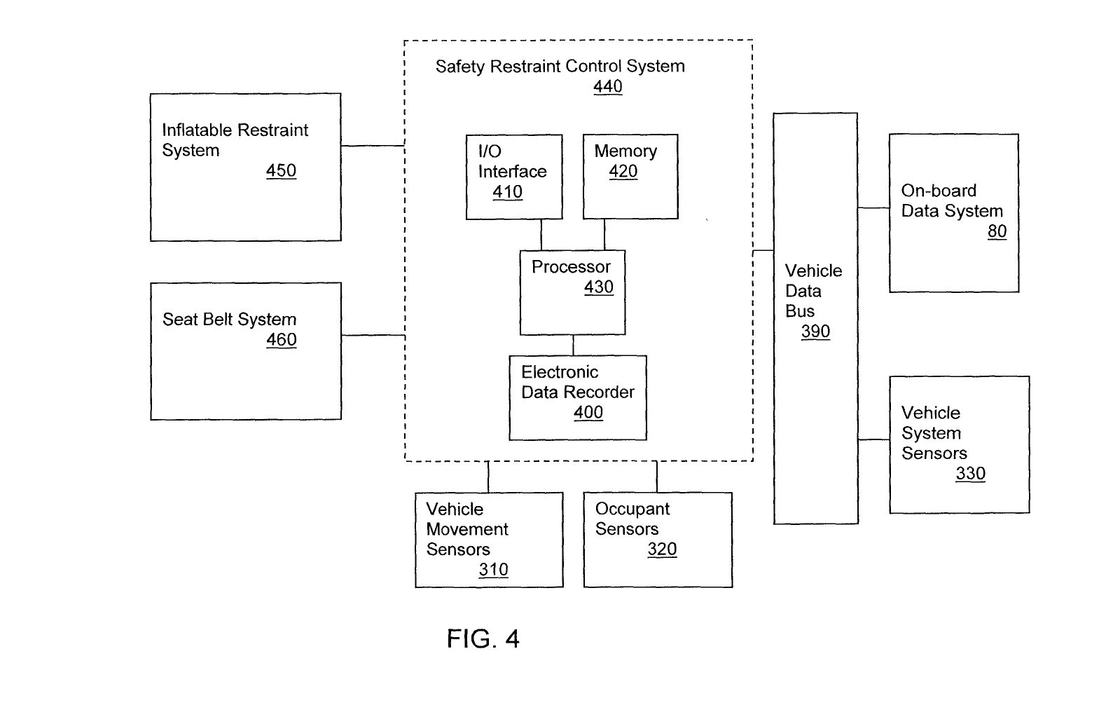

On-board Sensor Data 1030 is preferably captured by monitoring various On-board Sensors 90 and periodically storing measurements from On-board Sensors 90 based on a pre-defined measurement frequency in a buffer for a pre-selected period of time which correlates to the predicted duration of a crash event. The buffer could be any memory module within the vehicle, including the Memory 360 of the On-board Data System 80. It could also be the Memory 420 or Electronic Data Recorder 400 of a Safety Restraint Control System 440 as shown in FIG. 4. Additional On-board Sensor Data 1030 is also captured upon detection of a crash event. The specific On-board Sensor Data 1030 which is captured, as well as the frequency of capture and duration of capture, is preferably based upon a pre-determined relationship between the On-board Sensor Data 1030 and potential occupant injuries received in a crash event.

The On-board Data System 80 in FIG. 3 is shown as a computer containing a Processor 350, I/O Interface 370, and Memory 360. It is also shown with a Wireless Communications Device 270 and Location Device 280. The Wireless Communications Device may be any wireless device known in the art to be capable of transmitting data across a Wireless Network 100, including a wireless modem, cellular telephone, pager, radio or satellite terminal. The Location Device 280 is preferably a Global Positioning System (GPS) receiver, and could be any Radio Frequency (RF) device used to determine location through location-determination methods commonly known in the art including but not limited to Time Distance of Arrival, Angle of Arrival, wireless-assisted GPS, RF Fingerprinting and Loran. Location Network 290 is preferably the network of satellites which comprise the GPS System, and could represent a network used for one of the aforementioned location-determination methods or an advanced cellular network capable of determining the location of cellular transceivers.

The Wireless Communication Device 270 is preferably a digital or analog cellular radio and the Wireless Network 100 is preferably the digital or analog cellular radio system. Cellular radios and networks are commonly used in today's vehicle communication systems such as General Motors OnStar and Mercedes Tele-Aid. The Wireless Communication Device 270 enables crash data to be transferred through the Wireless Network 100 from the On-board Data System, where it is received by Control Center 110.

FIG. 4 shows the preferred embodiment where some of the On-board Sensors 300 function as part of a vehicle safety system, including a Safety Restraint Control System 440 containing an Electronic Data Recorder 400. In this embodiment, On-board Sensors 300 have the dual function of both: (1) control or measurement of vehicle systems; and (2) capture of crash event data that may be used in a Crash Data D & PS 130. The Safety Restraint Control System 440 may also serve the dual function of: (1) managing the performance of vehicle safety systems; and (2) serving as a collection and management point for crash event data. Safety Restraint Control System 440 preferably contains an I/O Interface 410, Memory 420 and Processor 430. Safety Restraint Control System 440 may receive data from Vehicle Movement Sensors 310, Occupant Sensors 320 and Vehicle System Sensors 330 and utilizes this data to manage performance of vehicle safety systems, including Inflatable Restraint System 450 and Seat Belt System 460. Inflatable Restraint System 450 is preferably a front or side airbag system. Electronic Data Recorder 400 records data from the Safety Restraint Control System 440, and stores this data in the event a vehicle crash is detected. Safety Restraint Control Systems 440 such as that depicted in FIG. 4 are known in the art and are used to assist with the performance of vehicle restraint systems. Electronic Data Recorders 400 are also known in the art, and may be used in a post-crash manner to evaluate the performance of a Safety Restraint Control System 440 located in a vehicle that has been involved in a crash event.

As shown in FIG. 4, On-board Sensor Data 1030 may be obtained from On-board Sensors 300 that function as part of a Safety Restraint Control System 440. This On-board Sensor Data 1030 is then transferred to an On-board Data System 80 allowing On-board Sensor Data 1030 to be wirelessly transmitted to a remote location by the On-board Data System 80. On-board Sensor Data 1030 may be stored in an Electronic Data Recorder 400, and Safety Restraint Control System 440 may be connected to an On-board Data System 80 through a Vehicle Data Bus 390. Those skilled in the art may know of several means for transferring data from the Safety Restraint Control System 440 to an On-board Data System 80 in order to allow On-board Sensor Data 1030 to be wirelessly transmitted to a remote location at the time of a crash event. This means may vary based on the type of vehicle or restraint control system as well as where and how the data is stored.

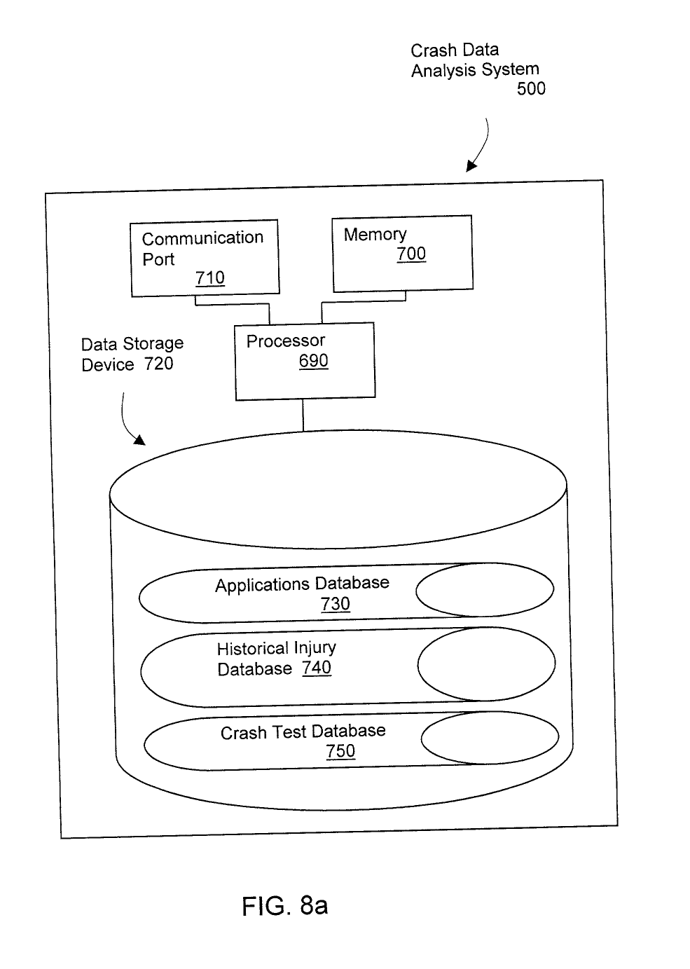

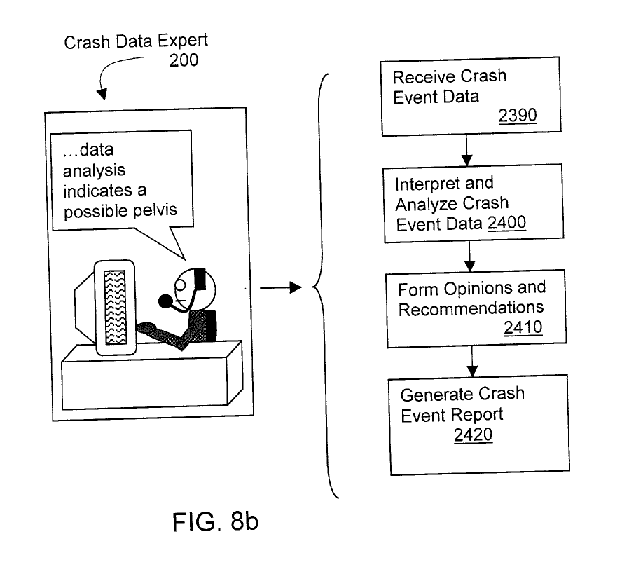

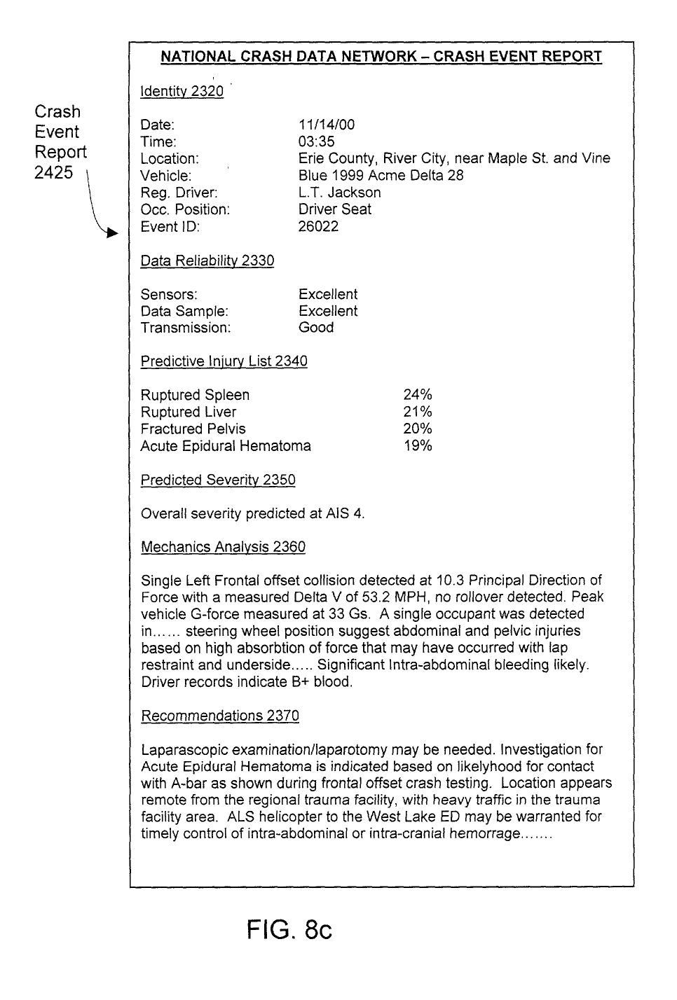

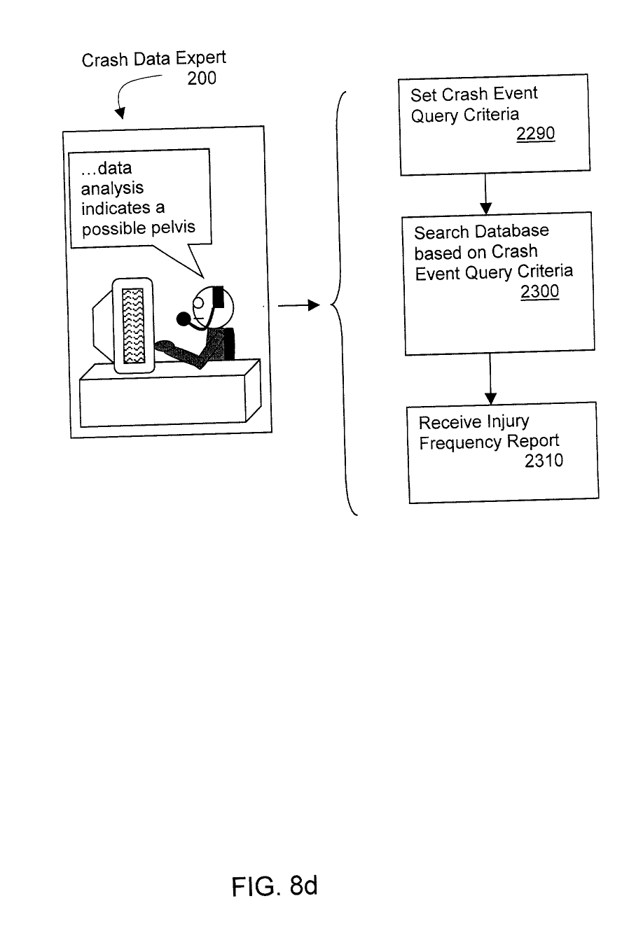

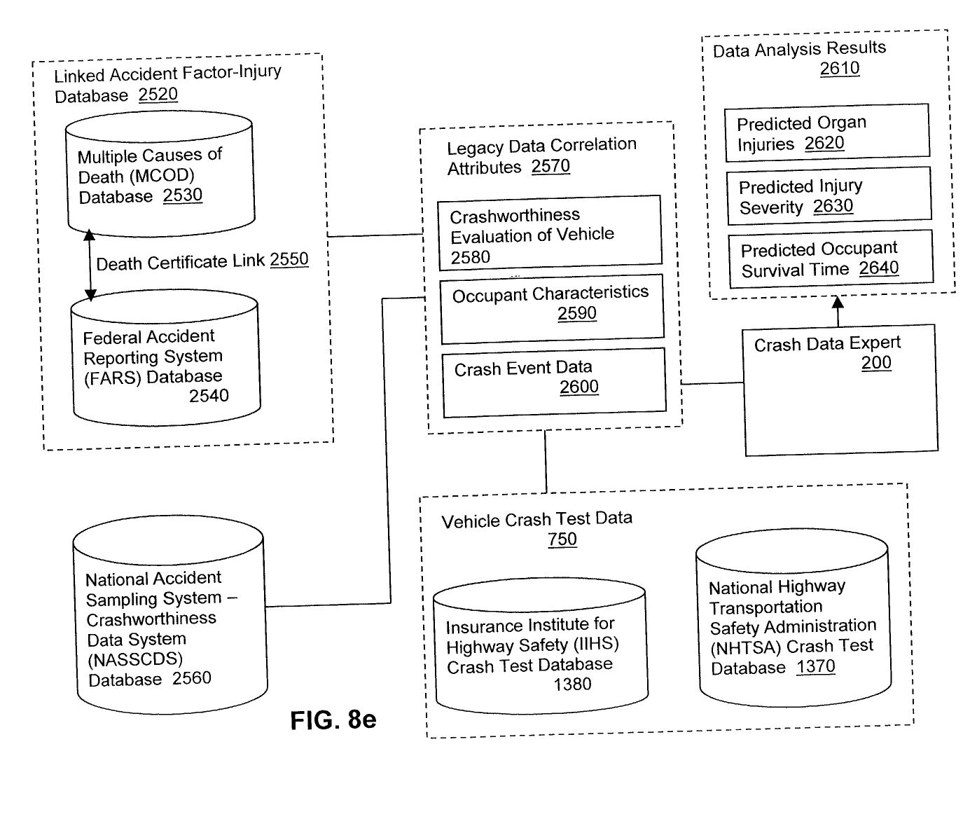

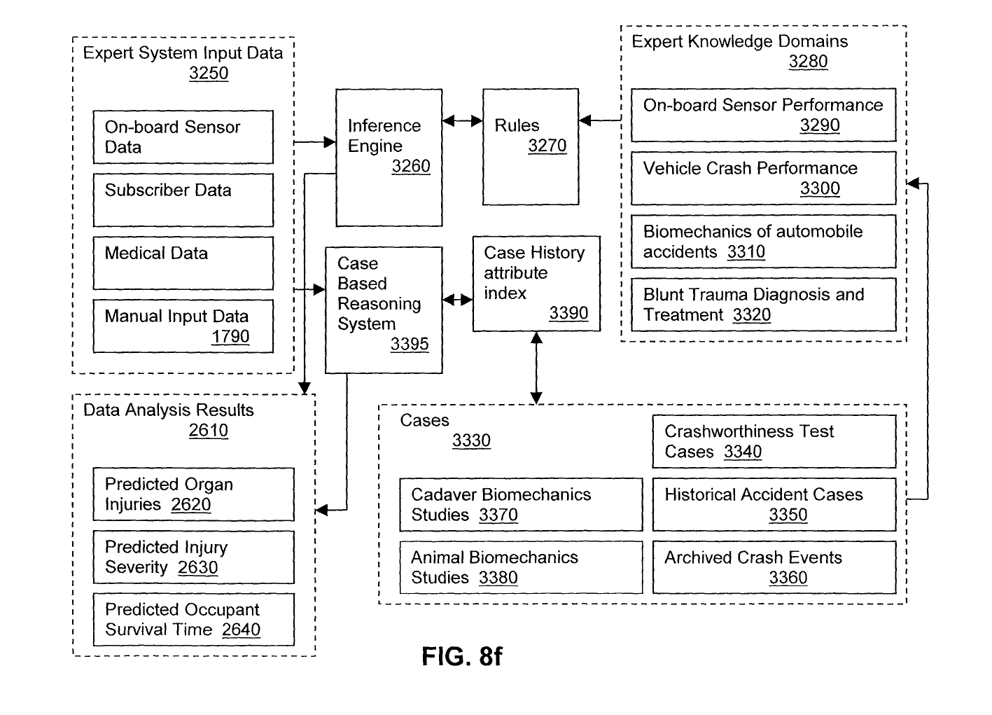

Vehicle Movement Sensors 310 and Occupant Sensors 320 which are part of a Safety Restraint Control System 440, are primarily designed to assist with proper deployment of an Inflatable Restraint System 450 to prevent injury caused by the Inflatable Restraint System 450 during a crash event while minimizing injury caused by the crash event forces. On-board Sensors 300 may capture, measure or transmit additional data beyond that necessary for performance of their control functions for vehicle systems or safety restraint systems, including data which has a pre-determined relationship to potential occupant movements, occupant injuries, vehicle movements or vehicle damage which may occur during a crash event. (See FIG. 8f for a system for development of relationships between On-board Sensor Data 1030 and potential occupant injuries). For example, Occupant Sensors 320 which detect the position of an occupant in relation to an inflatable restraint, could also be utilized to determine occupant positions subsequent to inflatable restraint deployment in order to determine occupant movements resulting from crash event forces and restraint use, including structures which may be struck by the occupant during the crash event.

Safety Restraint Control System 440 may also manage, process, store or transmit data from On-board Sensors 300 beyond that necessary for performance of managing restraint systems, including data which has a pre-determined relationship to potential occupant movements, occupant injuries, vehicle movements or vehicle damage which may occur during a crash event. Data elements from Vehicle Movement Sensors 310 and Occupant Sensors 320 may currently be monitored by Safety Restraint Control System 440 and recorded by an Electronic Data Recorder 400 at frequencies and durations which have a pre-determined relationship to their respective functions of managing and recording Safety Restraint Control System 440 performance. These sensors may be sampled and recorded at a different frequency and duration by Safety Restraint Control System 440 based on a pre-determined relationship to the additional function of determining potential occupant injuries received during the crash event.

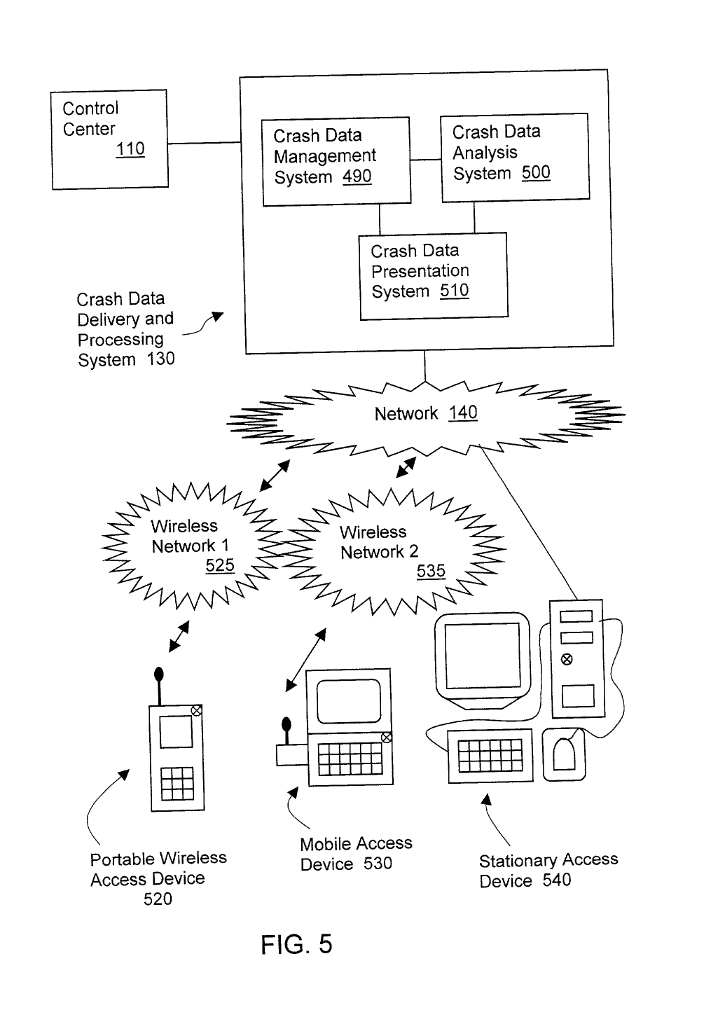

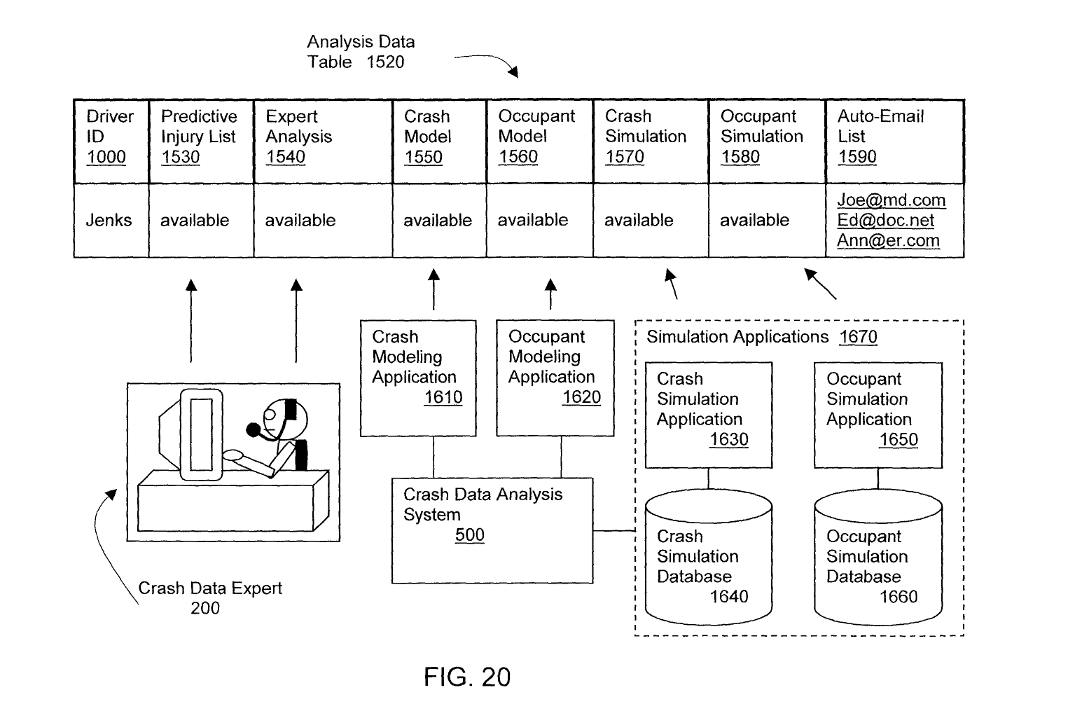

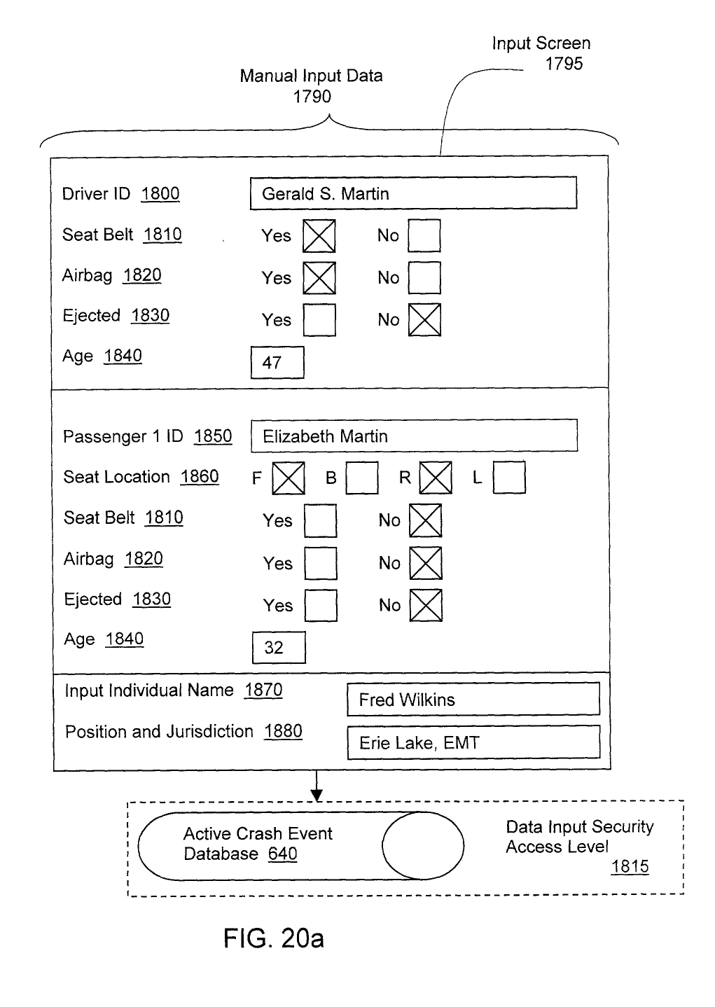

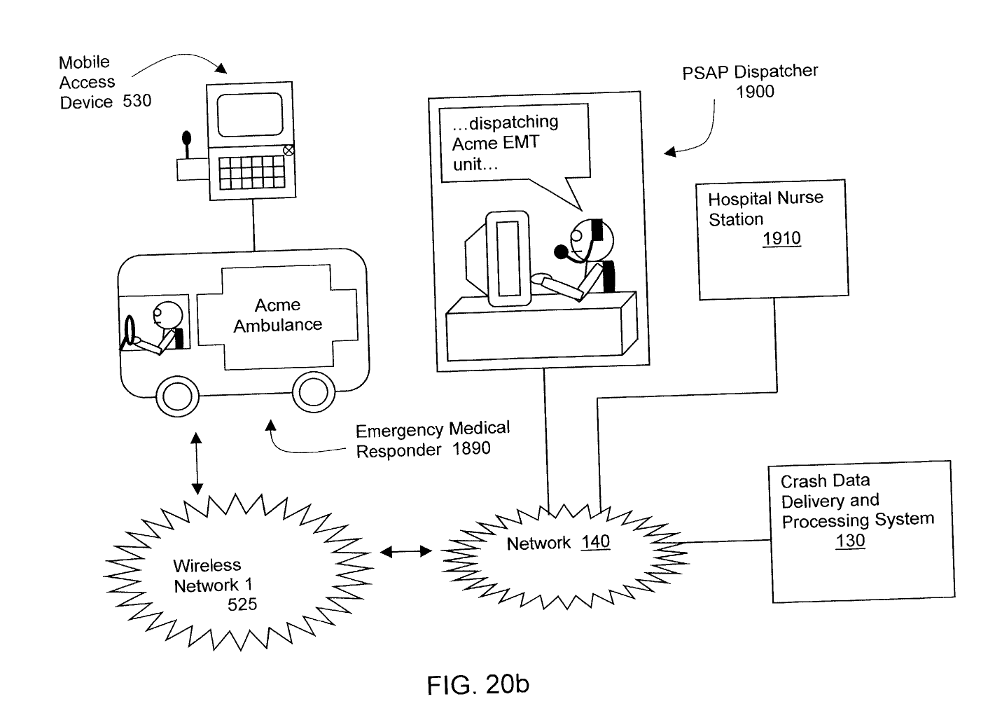

An exemplary block diagram of a Crash Data D&PS 130 is shown in FIG. 5 as being comprised of a Crash Data Management System 490 which receives On-board Sensor Data 1030 and subscriber data from the Control Center 110 relating to the crash event. A Crash Data Analysis System 500 assists with processing of On-board Sensor Data 1030 into a Crash Event Report 2425 that can be utilized by medical personnel and emergency responders to make treatment and handling decisions. An exemplary Crash Event Report 2425 is shown in FIG. 8c. The Crash Event Report 2425 may include crash event data including On-board Sensor Data 1030, analyzed On-board Sensor Data 1030, subscriber data, Manual Input Data 1790 (see FIGS. 20a and 20b) and external vehicle data. Crash Event Report 2425 may be automatically generated by the Crash Data D&PS, or may be generated with the assistance of Data Users 150 (See FIGS. 8b and 8c). External vehicle data includes crashworthiness data about the crashworthiness of a particular vehicle such as that contained in Crash Test Databases 750, as well as design data about vehicle design attributes such as dimensions, weights, safety features, materials, seating configurations, fuel systems, safety systems, seat and headrest attributes and other vehicle design attributes known to those skilled in the art.

Crash event data is analyzed and formatted by one or more software applications executed within the Crash Data Analysis System 500, and/or based on analysis by a Crash Data Expert 200. A Crash Data Presentation System 510 enables presentation of data to Data Users 150 through a Network 140. Data presented to Data Users 150 may include On-board Sensor Data 1030, data transferred from Control Centers 110 and outside data sources, and results from processing in the Crash Data Analysis System 500 through a Network 140. Data presented to Data Users 150 may include Crash Event Reports 2425 configured to the specific data needs of Data Users 150 or configured based on the type of communication device or access method being used by Data users 150 to access data.

As shown in FIG. 5, Data Users 150 may access the Crash Data D&PS 130 and Crash Event Reports 2425 through a variety of communication devices. A Stationary Access Device 540 is shown as a personal computer (PC) with a landline connection to Network 140. Stationary Access Device 540 is preferably a standard PC of common use by the Data User 150 for non-Crash Data D&PS 130 applications, with a commonly used operating system such as Microsoft Windows and standard web browser software such as Microsoft Explorer or Netscape Navigator for viewing data presented by the Crash Data D&PS 130 via the internet. Stationary Access Device 540 may be a PC located in any facility where access to crash event data may be desired, including:

Hospital Emergency Department

Trauma center

Operating room

Nurse Station

Physician Office

Public Safety Agency

Control Center

Emergency Response Agency Fleet Management Center

Vehicle Rescue and Extrication Agency

Commercial Vehicle Fleet Management Center

Crash Data Analysis Center

Insurance claims Center

Accident Reconstruction Agency

Government Agency

University

Research Center

Wireless access is also shown for mobile Data Users 150, including a Portable Wireless Access Device 520 and a Mobile Access Device 530. Portable Wireless Access Device 520 is preferably a wireless phone or personal digital assistant (“PDA”) with wireless communications capability such as a cellular modem or pager. Crash Data Presentation System 510 is preferably enabled for internet content viewing via standard wireless internet delivery protocols allowing limited access to internet site data through standard wireless devices without the need for Data Users 150 to purchase wireless equipment having capabilities, configurations or software different than that which is commonly used by consumers and business personnel for wireless internet access. Wireless internet protocols currently in use or development for portable wireless devices include:

Wireless Internet Access and Applications Protocols

Email

Wireless Application Protocol (“WAP”)

VxML and Voice Browsing

One-Way Short Message Service

Two-Way Short Message Service

Palm Web Clipping

WML

HDML

XML

WebWirelessNow

Java K Virtual Machine (“KVM”)

Portable Wireless Access Device 520 may be utilized by paramedics responding to an automobile accident dispatch request, or other emergency personnel responding to an accident scene such as police, nurses, physicians, surgeons, accident reconstruction personnel and insurance personnel. Crash Data Presentation System 510 preferably configures crash event data into a Crash Event Report 2425 for rapid retrieval of relevant crash event data by Data Users 150 utilizing Portable Wireless Access Devices 520. Capabilities which may assist in this process may include recognition of voice commands by the Crash Data D&PS 130 using a voice recognition technology engine.

Portable Wireless Access Device 520 accesses content from the Crash Data Presentation System 510 through Wireless Network 1 525, which is preferably a commonly used wireless communication system, including:

Wireless Communication Systems

GSM

GPRS

TDMA

CDMA

AMPS

CDPD

FLEX

REFLEX

MOBITEX/RAM

ARDIS

Metricom

Netxtel

A Mobile Access Device 530 is also shown in FIG. 5, which is preferably a notebook or laptop computer which enables full internet access through use of a wireless modem, such as a circuit-switched analog modem, Cellular Digital Packet Data radio or digital cellular radio modem based on one of the digital cellular standards such as GSM, TDMA or CDMA, or combination of any of the preceding. Mobile Access Device 530 accesses content through Wireless Network 2 535 which may also be one of the standard wireless communication systems listed above. Mobile Access Device 530 preferably enables access to the full functionality of the Crash Data D&PS 130 with comparable capabilities to a Stationary Access Device 540.

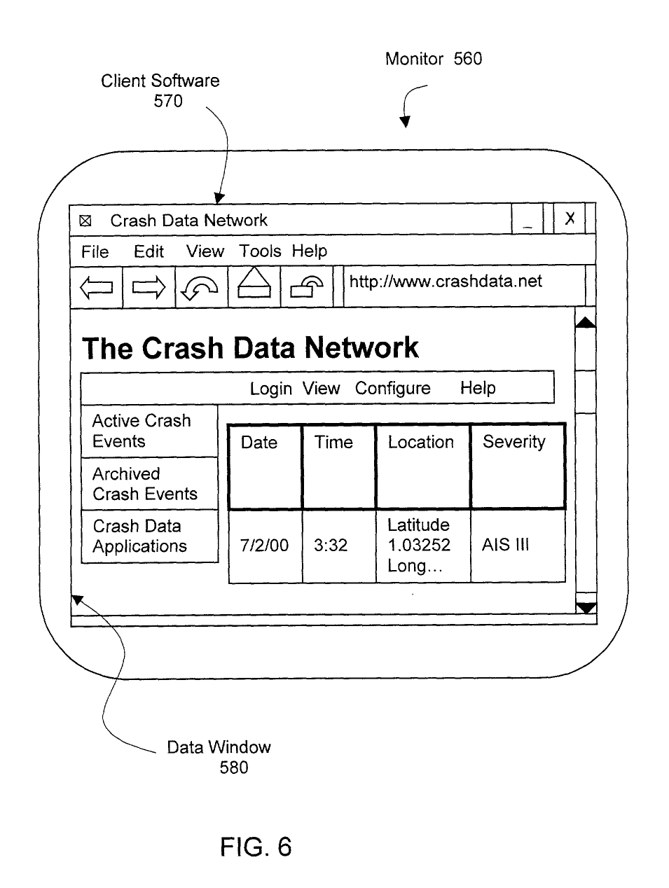

FIG. 6 shows an exemplary user interface for accessing information from the Crash Data D&PS 130. The Data Window 580 displays the data from the Crash Data D&PS 130, including crash event record data, Crash Event Reports 2425 and other information obtained from On-board Sensors 90, Subscriber Databases 210, and other information inputs into the Crash Data D&PS 130. A Monitor 560 is shown as providing Data Window 580, which could be any computer monitor suitable for displaying data through personal computer software, including a standard PC monitor or monitor from a notebook, laptop, or other form of mobile computing device. Client Software 570 is preferably a common and standard internet browser that can be downloaded through Network 140.

Data Management System

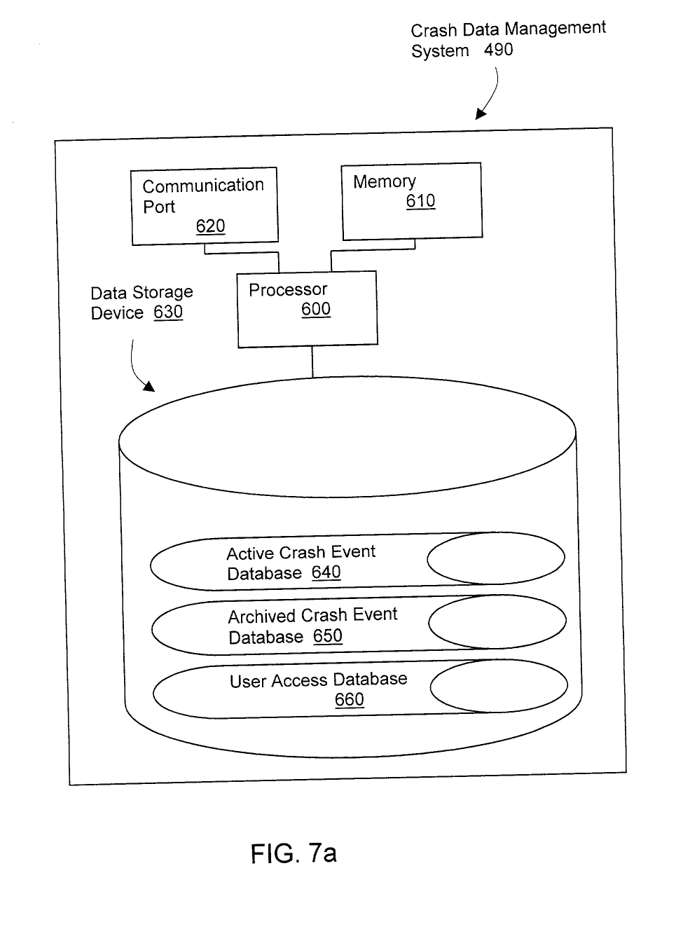

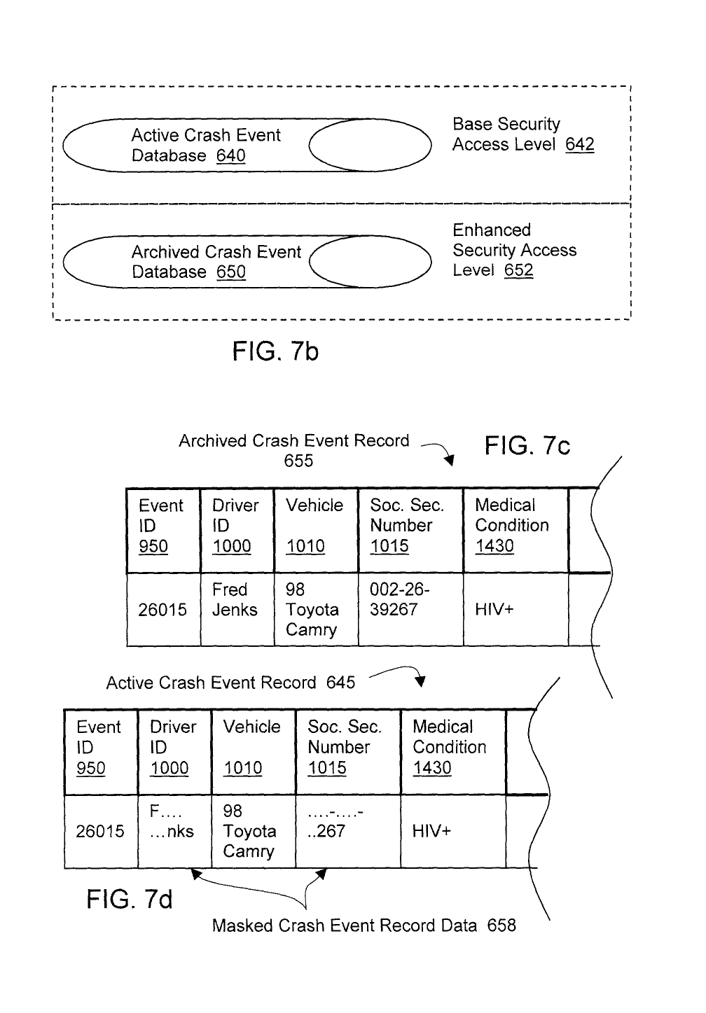

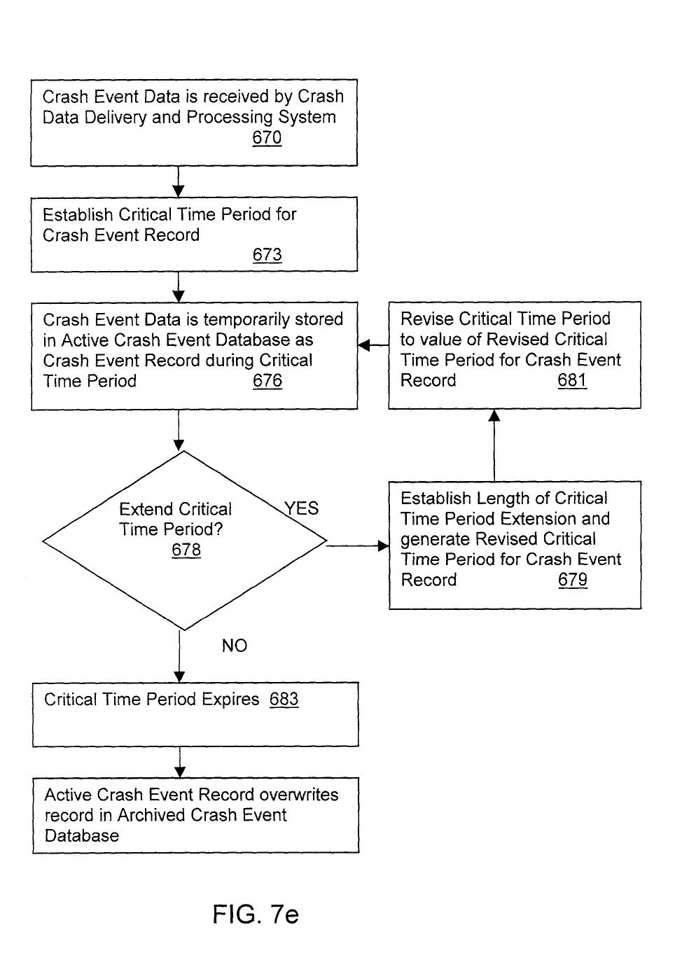

FIG. 7a depicts a block diagram of a Crash Data Management System 490, shown as a central database server. The primary function of the Crash Data Management System 490 is to manage the data records of the Crash Data D&PS 130. A Data Storage Device 630 is shown which may contain a variety of databases, including Active Crash Event Database 640, Archived Crash Event Database 650 and User Access Database 660. The Crash Data Management System 490 includes a Processor 600, Communication Port 620, and Memory 610 for managing the operations of the Crash Data Management System 490, including: (1) inputting of new crash event data; (2) data inquiries regarding specific records; (3) data inquiries for display of current crash events through Crash Data Presentation System 510; (4) management of Data User 150 access; (5) transfer of crash event records from Active Crash Event Database 640 to Archived Crash Event Database 650; and (6) database searches and queries for data analysis by Data Users 150.

The Active Crash Event Database 640 contains time-sensitive data regarding recent crash events and is preferably easily accessible by those providing emergency response and medical services to potentially injured vehicle occupants. The Active Crash Event Database 640 is shown in FIG. 7b as employing a Base Security Access Level 642. Data in the Active Crash Event Database 640 will often be used to support emergency response services and immediate medical treatment to individuals injured in the subject crash event, including decisions relating to triage, transport, resource allocation, resource scheduling, severity scoring, injury diagnosis and treatment. Base Security Access Level 642 may be a warning only, and preferably allows open access without requirement for a password. The Archived Crash Event Database 650 contains records which are not as time-sensitive, does not need to be as accessible, and employs an Enhanced Security Access Level 652 to protect the privacy of individual records from public disclosure.

Active Crash Event Records 645 may be displayed in a manner that enables sensitive data to be partially or completely inaccessible to Data Users 150 accessing Active Crash Event Records 645 through Network 140, while enabling the missing data to be determined or confirmed using other means. Here, a Masked Crash Event Record Data 658 is shown in FIG. 7d that prevents complete public disclosure of personal identification information while still allowing rapid and unrestricted access for Data Users 150. Masked Crash Event Record Data 658 may partially or completely conceal one or more personal identification data fields from disclosure. Data Users 150 may verify the data in Masked Crash Event Record 658 by looking up the record in the Archived Crash Event Database 650 or comparing partial data found in the Masked Crash Event Record 658 with personal identification information found in the possession of injured vehicle occupants. Active Crash Event Records 645 are stored in Active Crash Event Database 640 temporarily based on a Critical Time Period in which relatively open data access is desired. All Active Crash Event Records 645 are also stored in duplicate in the Archived Crash Event Database 650 (shown in FIG. 7c), with the Archived Crash Event Database 650 record being overwritten by the Active Crash Event Record 645 for the subject event at expiration of the Critical Time Period.

FIG. 7e illustrates a process for determining when to transfer Active Crash Event Records 645 to the Archived Crash Event Database 650 using a Critical Time Period. After Crash Event Data is received 670 then a Critical Time Period is established 673 and Crash Event Data is temporarily stored in the Active Crash Event Database 640 as an Active Crash Event Record 645 until the Critical Timer Period has ended 676. A decision may be made to extend the Critical Time Period 678, in which case a Revised Critical Time Period is established 679 replacing the originally established Critical Time Period 681. If not extended, the Critical Time Period Expires 683 and the Crash Event Record overwrites the record for the event in the Archived Crash Event Database 688.

Analysis System

FIG. 8a depicts a block diagram of a Crash Data Analysis System 500, shown as a central applications server. The Crash Data Analysis System 500 may be utilized by Crash Data Experts 200 as well as by other Data Users 150, and serves a primary function of interpreting and analyzing On-board Sensor Data 1030 and other related data. The Crash Data Analysis System 500 includes a Processor 690, Communication Port 710, and Memory 700 for managing the operations of the Crash Data Analysis System 500, which may include: (1) Analyzing crash event severity to assist in determining appropriate level of emergency response; (2) Predicting potential occupant injuries; (3) Predicting injury severity scores; (4) Predicting occupant survival probabilities; (5) predicting occupant survival times; (6) modeling crash event vehicle movements; (7) modeling crash event occupant movements; (8) Predicting occupant injury mechanisms; (9) Predicting medical resources and medical procedures needed for injured occupant treatment; (10) Providing recommended diagnostic or treatment protocols. The Data Storage Device 720 is also shown which may contain a variety of databases utilized by the Crash Data Analysis System 500, including an Applications Database 730 and databases containing legacy data which may be used in the analysis of crash event data such as a Historical Injury Database 740 and a Crash Test Database 750.

A simplistic illustration of the use of the Crash Data D&PS 130 by Data Users 150, here shown as Crash Data Experts 200, is illustrated in FIG. 8b. First, Crash Data Experts 200 receive crash event data 2390. Second, Crash Data Experts 200 interpret and analyze crash event data 2400. Third, Crash Data Experts 200 form opinions and recommendations regarding crash event data 2410. Shown as a fourth step 2420, some Data Users 150, particularly Crash Data Experts 200, may also generate a Crash Event Report 2425 for communication of crash event data to other Data Users 150 or other parties interested in viewing crash event data.

FIG. 8c illustrates an exemplary Crash Event Report 2425, here shown as a highly detailed communication generated with input from Data Users 150 in the form of Crash Data Experts 200. Crash Event Reports 2425 may include Onboard Sensor Data 1030, interpretations of On-board Sensor Data 1030 by Crash Data Experts 200, as well as the results of applications run within the Crash Data Analysis System 500 which are either selectively run by Crash Data Experts 200 or automatically run by the Crash Data Analysis System 500 upon the occurrence of a crash Event. Identity Data 2320 may be included in Crash Event Reports 2425 in order to correctly match the crash event data to the injured vehicle occupants. Identity Data 2320 may be derived from Subscriber Database 210 and preferably includes data regarding the date, time and location of the crash event, as well as identifying information regarding the vehicle, the registered vehicle driver, the occupant position for the injured occupant and an event ID. Data Reliability Data 2330 may be included in order to give Data Users 150 an indication of the data value and accuracy. Data Reliability Data 2330 preferably includes an analysis of the reliability of sensor data, the data sample that was transmitted, and the quality of the transmission. Predictive Injury List 2340 may be included in order to assist emergency response agencies and medical treatment providers in making treatment and handling decisions regarding an injured vehicle occupant. Predictive Injury List 2340 may be included, and preferably includes a list of most likely injuries, with probabilities of the likelyhood that these injuries are present. Predicted Severity 2350 may be included in order to assist emergency response agencies and medical treatment providers in making treatment and handling decisions regarding an injured vehicle occupant. Predicted Severity 2350 preferably includes an AIS score, and may include scores from any commonly used trauma scoring systems. Mechanics Analysis 2360 may be included, in which an analysis and interpretation of crash event data is provided by a Crash Data Expert 200. Mechanics Analysis 2360 preferably includes an analysis of vehicle movements, occupant position, restraint use and likely movements, likely injury mechanisms, injuries to watch for and any other data or data analysis which may assist emergency response agencies, medical treatment providers and others engaged in the handling and treatment of the injured occupant. Mechanics Analysis 2360 may also include explanations of reasoning utilized by Crash Data Expert 200 and justifications for conclusions reached by Crash Data Expert 200, including the use of any computer-assistance for conclusions. Recommendations 2370 may be included in which actions are suggested for those involved in the handling and treatment of the injured vehicle occupant. Recommendations 2370 preferably includes recommendations for transport, diagnosis and treatment of an injured vehicle occupant, and any other recommendations which may assist emergency response agencies and medical treatment providers in the handling and treatment of an injured vehicle occupant. Crash Event Reports 2425 can be configured to the specific data needs of various Data Users 150, as well as the access devices used to access Network 140. Crash Event Reports 2425 can be relatively complex as shown in FIG. 8c, or as simple as transmitting an accident severity reading to an EMT's Portable Wireless Access Device 520 in the field.

Data Users 150 may also utilize data stored in the Crash Data Management System 490 to assist them in interpreting crash event data, as illustrated in FIG. 8d. Data User 150 is shown as a Crash Data Expert 200 running a database query in order to determine the frequency of injuries found in past crash events based on query criteria established by the Crash Data Expert 200. First, crash event query criteria is set 2290. Second, crash event query criteria is used to search a database 2300. The database searched could be the Archived Crash Event Database 650 as shown in the Crash Data Management System 490 in FIG. 7a, or a Historical Injury Database 740 as shown in the Crash Data Analysis System 500 in FIG. 8a. Third, the database query returns an injury frequency report 2310. The injury frequency report preferably contains a listing of probabilities of each injury contained in the injury frequency report based on the number of matching database injuries found which list each injury as a potential injury based on the event query criteria which was used.

In cases where it is desirable to search a legacy database which does not contain On-board Sensor Data 1030, Legacy Data Correlation Attributes 2570 may be used to link characteristics of a crash event to characteristics of historical crash events contained in legacy databases as illustrated in FIG. 8c. Legacy Data Correlation Attributes 2570 may include a Crashworthiness Evaluation of Vehicle 2580, which could be a relative measure of vehicle crashworthiness such as a NHTSA or IIHS crash test score. Other attributes may include Occupant Characteristics 2590 where records are compared based on age, gender, size or weight of occupants. Other attributes may include Crash Event Data 2600 that can be correlated between databases such as Delta V, principal direction of force and restraint use. Legacy Data Correlation Attributes 2570 may be created on a case-by case basis after crash event data is received, or may be created in advance of crash events based on particular rules which may be stored in, and selected from a database. Legacy Data Correlation Attributes 2570 may be manually determined by a Crash Data Expert 200, or may be generated by a software application within the Crash Data Analysis System 500.

Data sources for correlation include a Linked Accident Factor-injury Database 2520 created by linking the Multiple Causes of Death (MCOD) Database 2530 and the Federal Accident Reporting System (FARS) Database by a Death Certificate Link 2550. Another data source for correlation may include the National Accident Sampling System—Crashworthiness Data System (NASSCDS) Database 2560. Another data source for correlation may include a Vehicle Crash Test Database 750, including the Insurance Institute for Highway Safety (IIHS) Crash Test Database 1380 or the National Highway Transportation Safety Administration (NHTSA) Crash Test Database 1370.

FIG. 8f shows an application within the Crash Data Analysis System 500 in the form of an expert system which automatically generates Data Analysis Results 2610 based on Expert System Input Data 3260. An Inference Engine 3260 is used to generate Data Analysis Results 3260 based on Rules 3270 Established by experts in various Expert Knowledge Domains 3280 including Onboard Sensor Performance 3290, Vehicle Crash Performance 3300, Biomechanics of Automobile Accidents 3310 and Blunt Trauma Diagnosis and Treatment 3320. Data Analysis Results 2610 may also be generated by a Case Based Reasoning System 3395 which utilizes Cases 3330 as a knowledge base by linking attributes of a crash event to attributes of cases using a Case History Attribute Index 3390. Cases 3330 may include Crashworthiness Test Cases 3340, Historical Accident Cases 3350, Archived Crash Events 3360, Cadaver Biomechanics Studies 3370 and Animal Biomechanics Studies 3380. Cases 3330 may be indexed into a relational database.

Inference Engine 3260 may utilize any rules-based logic scheme, including use of boolean algorithms to generate Data Analysis Results 2610 from Rules 3270. Case Based Reasoning System 3395 may utilize any form of comparison logic scheme, including probability-based algorithms (including Bayesian algorithms) to determine the relative probabilities for presence of particular organ injuries.

Presentation and Delivery System

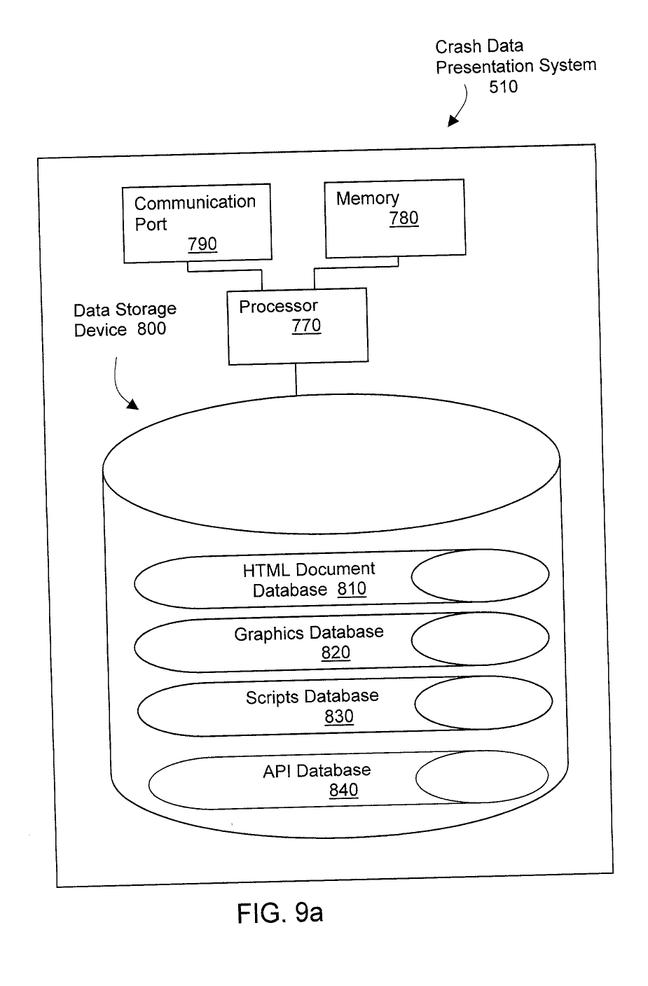

FIG. 9 depicts a block diagram of a Crash Data Presentation System 510, shown as a central web server. The primary function of the Crash Data Presentation System 510 is to communicate crash event data to Data Users 150 in a controlled manner. The Crash Data Presentation System 510 includes a Processor 770, Communication Port 790, and Memory 780 for managing the operations of the Crash Data Presentation System 510, which may include: (1) Displaying crash event data at a specific network location such as an internet address; (2) Managing network requests for data in coordination with the Crash Data Management System 490; (3) Managing specific application requests and delivery of application results in coordination with the Crash Data Analysis System 500; (4) Managing data display configuration requests by data users 150; (5) Managing Data User 150 access; (6) Tracking network utilization; (7) Serving-up forms for data input into Crash Data Management System 490; (8) Facilitating and managing wireless access to data and applications; and (9) Delivering reports via email, fax, voice, and various wireless delivery mechanisms.

The Data Storage Device 800 is also shown which may contain a variety of databases, including an HTML Document Database 810, a Graphics Database 820, a Scripts Database 830 and an API Database 840.

Push Data Delivery

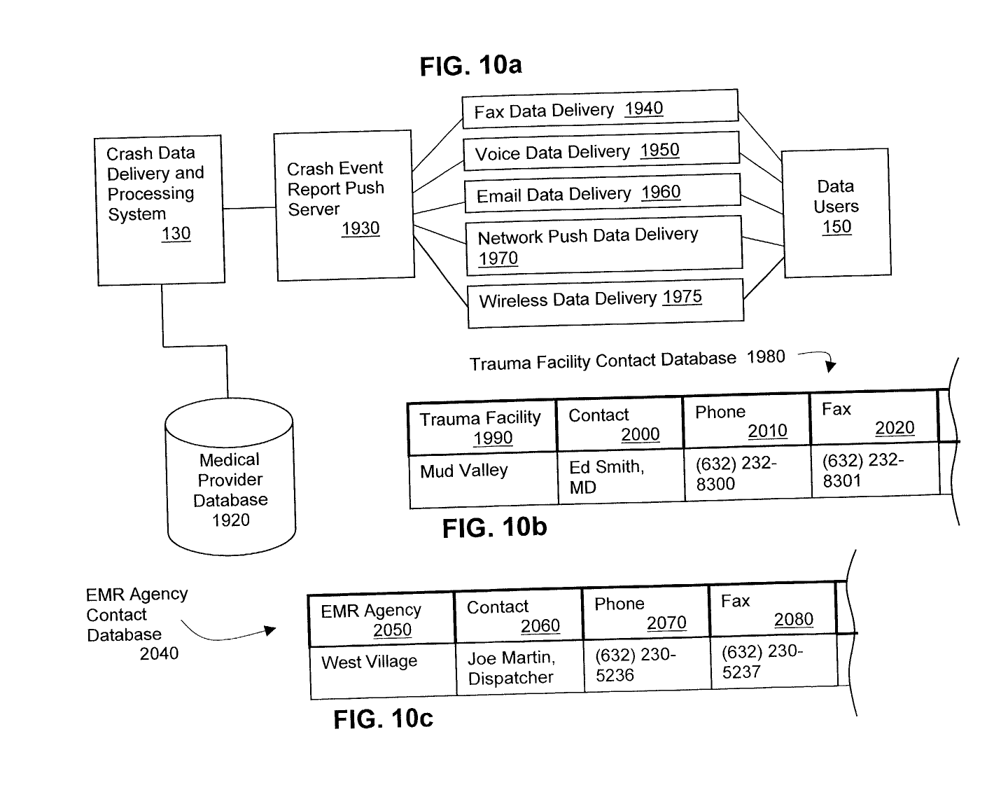

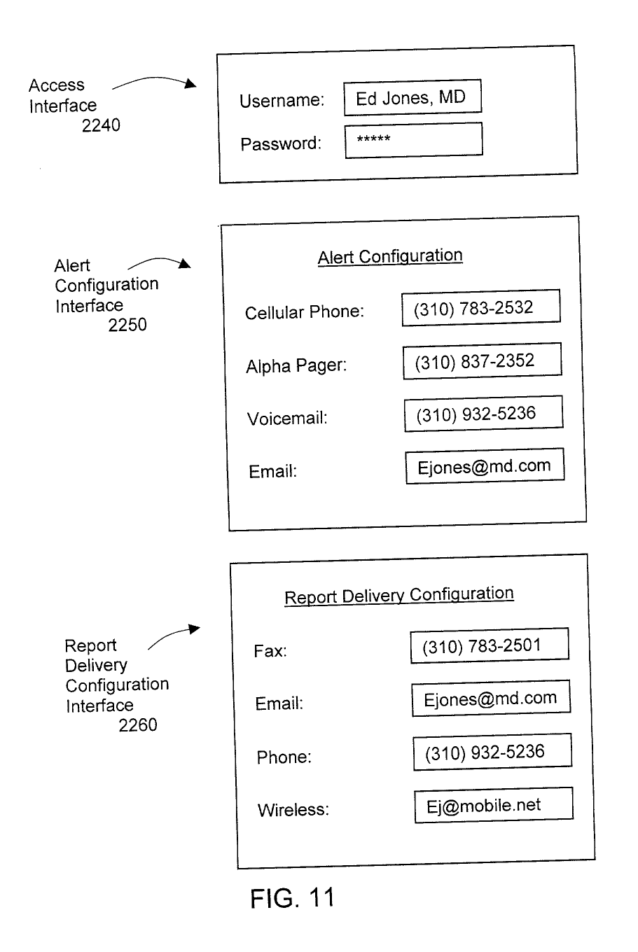

Crash Event Reports 2425 may be delivered to Data Users 150 using a variety of push-type mechanisms as illustrated in FIG. 10a, including Fax Data Delivery 1940, Voice Data Delivery 1950, Email Data Delivery 1960, Network Push Data Delivery 1970 or Wireless Data Delivery 1975. Crash Event Reports 2425 may pushed to Data Users 150 by a Crash Event Report Push Server 1930 to a certain address retrieved from a Medical Provider Database 1920 or from information input by a Data User 150 through a Report Delivery Configuration Interface 2260 as shown in FIG. 11. Crash Event Report Push Server 1930 may include a fax server, voice server, email server, http address server, wireless data server or any automatic data delivery system which utilizes an address retrieved from a database for delivery of a Crash Event Report 2245. Push delivery addresses which may be used to send Crash Event Data to Data Users 150 may include:

Push Delivery Addresses

Fax Number

Phone Number

Email Address

Network Address (such as an http address)

Mobile Identification Number

Mobile Email Address

Mobile Network Address

FIG. 10b shows an example of a Trauma Facility Contact Database 1980 which may be used to send data to a Trauma Facility 1990 by directing the data to a specific Contact 2000. FIG. 10c shows an example of an EMR Contact Database 2040 which enables the sending of data to a EMR Agency 2050 by directing the data to a specific Contact 2060.

Delivery Configuration

FIG. 11 illustrates three configuration interface screens which allow Data Users 150 to configure the manner in which they are alerted regarding crash event data and the manner in which Crash Event Reports 2425 or other forms of crash event data is delivered, including an Access Interface 2240 for gaining access to configuration functions, an Alert Configuration Interface 2250 for inputting of alert address information by a Data User 150, and a Report Delivery Configuration Interface 2260 for specifying an address for which a Data User 150 wants Crash Event Reports 2425 or other crash event data to be automatically delivered. The Alert Configuration Interface 2250 allows a Data User to be alerted when a crash event has occurred in their area which they may need to be aware of, and allows them to choose the manner in which they would like to be alerted. The Report Delivery Configuration Interface 2260 allows a Data User 150 to receive a Crash Event Report 2425 to an address they specify, in the manner in which they would like to receive the information.

Collaboration Functions

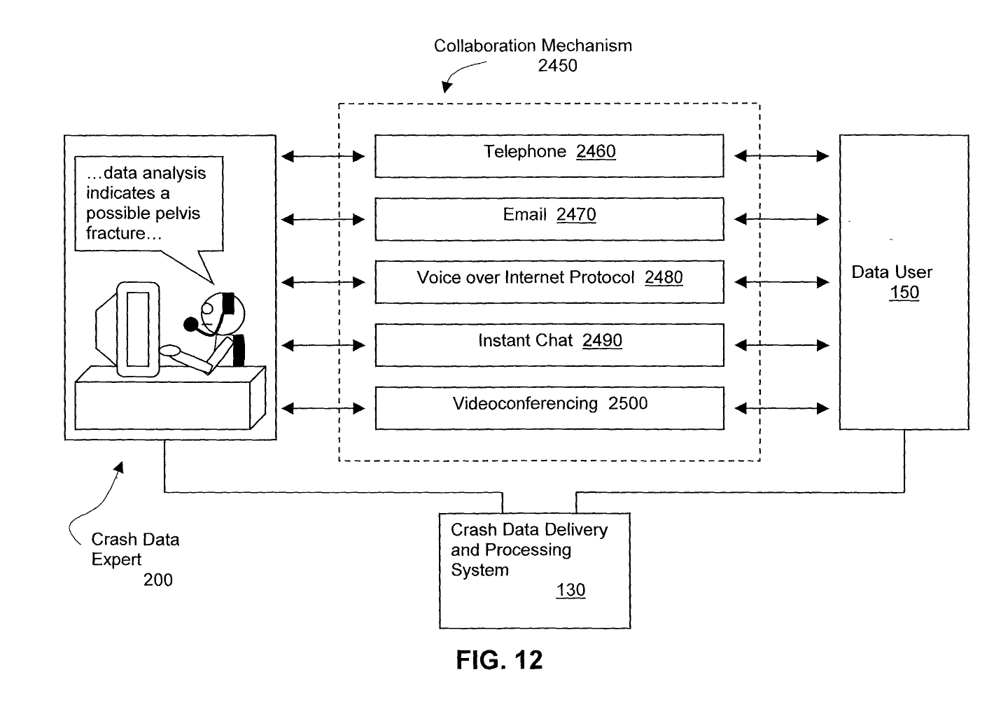

FIG. 12 illustrates an exemplary Collaboration Mechanism 2450 which may be used for Data Users 150 to discuss crash event data and Crash Event Reports 2425 with Crash Data Experts 200 using multiple forms of two-way communication. Collaboration Mechanism 2450 may take the form of any type of reliable two-way communication mechanism, including Telephone 2460, Email 2470, Voice over Internet Protocol 2480, Instant Chat 2490 and Videoconferencing 2500. Preferably both Data Users 150 and Crash Data Experts 200 are connected to the Crash Data D&PS 130 at the time of collaboration, or are simultaneously viewing a Crash Event Report 2425 for a particular crash event in order to jointly discuss and analyze data regarding a particular crash event, including On-board Sensor Data 1030, crash event data, data reliability, data interpretation, application results, predicted diagnosis, response and treatment resources, and potential courses of treatment.

Geographic Configuration

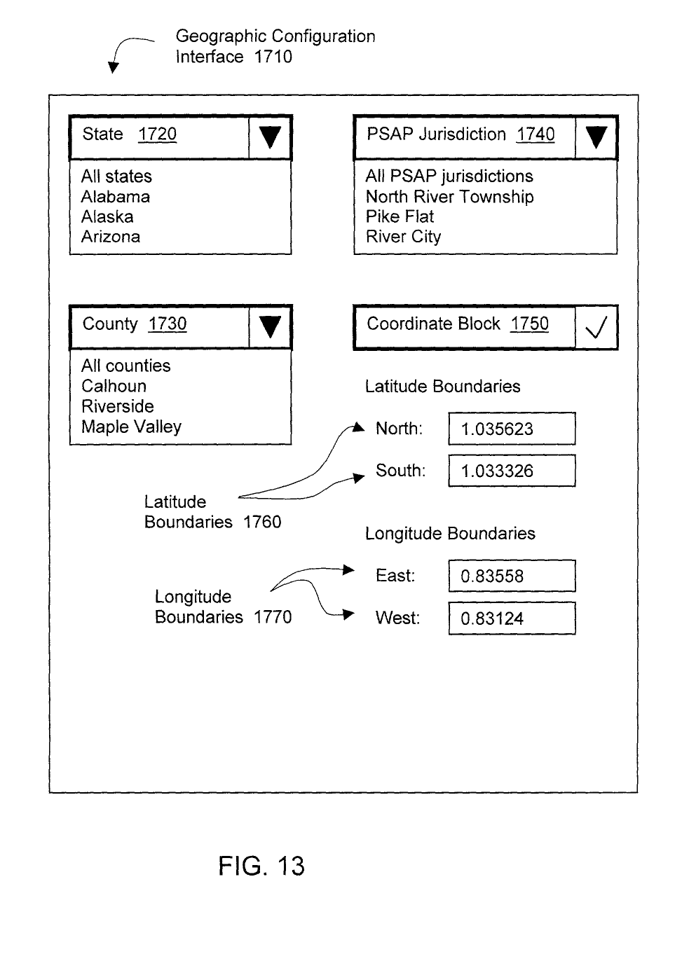

FIG. 13 shows a Geographic Configuration Interface 1710 which allows a Data User 150 to determine the geographic areas of crash events that they would like displayed to them when the access the Crash Data D&PS 130. Configuration settings selected by Data Users 150 may be retained by storing configuration settings in a cookie stored on the Data User's 150 computer hard drive, or in a User Access Database 660 in the Crash Data Management System 490 which contains a reference identifier which matches a reference identifier in a cookie stored on the Data User's computer hard drive. Configuration settings may be stored by other means known in the art for storing configuration settings. Data Users 150 may refine the number of crash event records displayed to them by selecting the State 1720, County 1730 or PSAP Jurisdiction 1740 within which the location of event records must exist in order for them to be displayed to Data User 150. Alternatively, Data User may configure crash event records displayed based on Coordinate Block 1750 by entering values for Latitude Boundaries 1760 and Longitude Boundaries 1770 which correspond to the geographic coverage area desired.

Data Structure

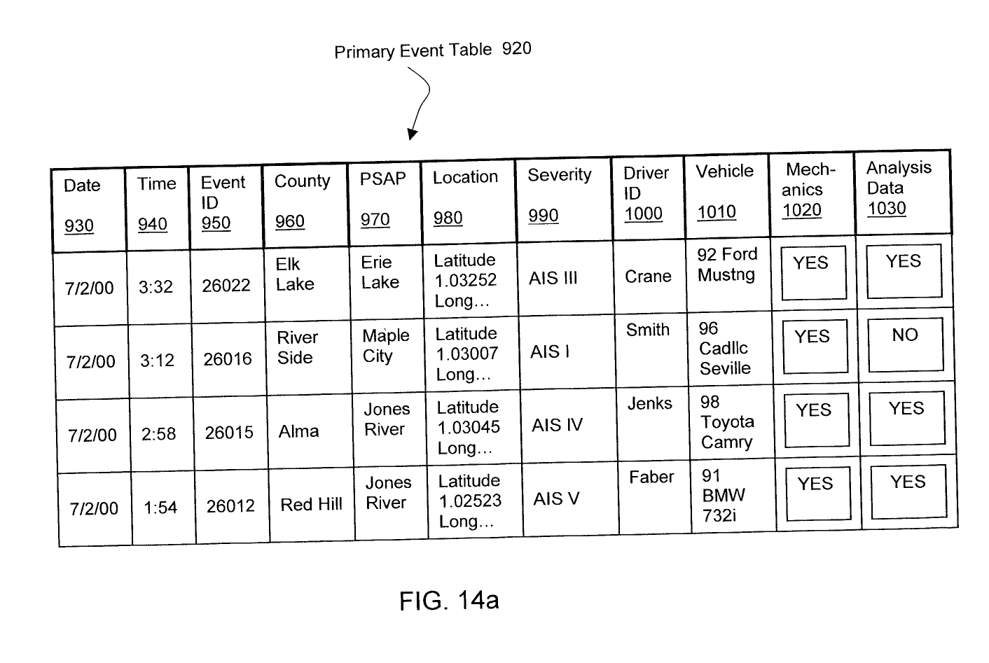

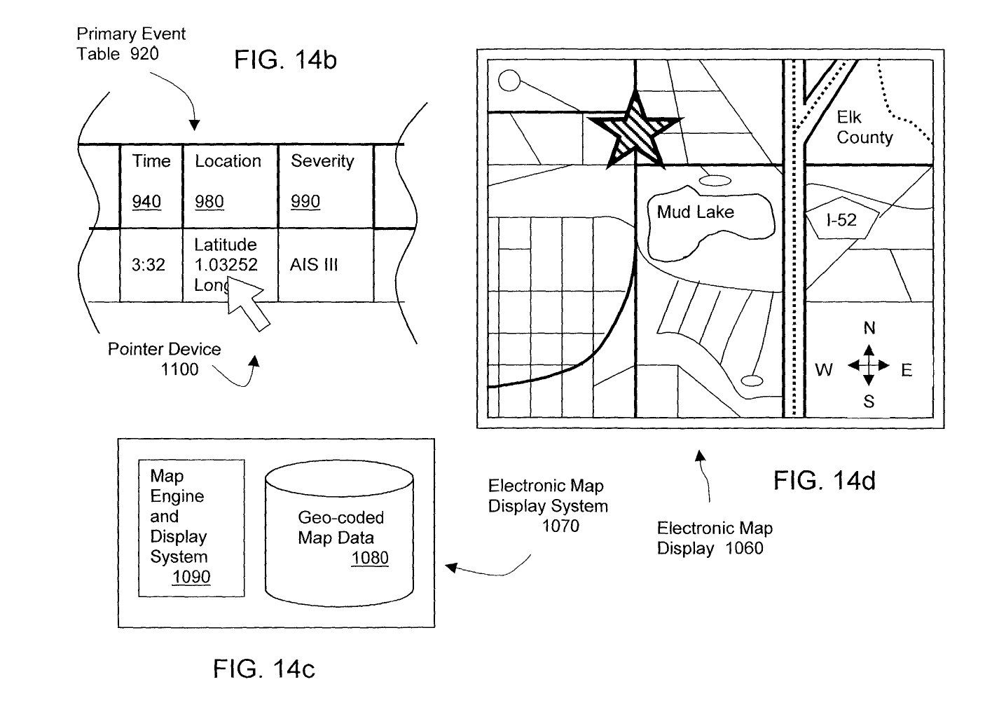

FIG. 14a illustrates an exemplary Primary Event Table 920 that may be used as the default display of Active Crash Event Data to Data Users 150. The function of the Primary Event Table 920 is to provide a Data User 150 with an overview of relevant crash events. When a crash event occurs, a date and time of the event may be measured, which can be generated by a GPS receiver, a Control Center 110 or the Crash Data D&PS 130 or any other computer that is notified of the crash event. The measured date and time of the crash event populates a Date 930 field and Time 940 field in Primary Event Table 920, and will indicate to the Data User 150 whether the data in a given record is relevant to a timely crash event in which emergency assistance may be needed. Individual crash event records are identified by the Crash Data D&PS 130 by an Event ID 950 which may be assigned by the Crash Data Management System 490. A County 960 is shown, which will help Data Users determine the locale of a given event, and assist them in determining which crash events may require their involvement. County 960 data for each crash event may be obtained from analysis of GPS or other location coordinates of the crash event which may be transmitted by the On-board Data System 80 to the Control Center 110, or in cases where location coordinates are unavailable this data may be obtained by vehicle occupants or emergency responders. A PSAP 970 is also shown, which represents a Public Safety Answering Point (PSAP), which will also help Data Users 150 determine which crash events may require their involvement, and will also alert them regarding public safety agencies with whom they may need to coordinate response resources. PSAP 970 identification data will in most cases be obtained from the Control Center 110 as described in FIG. 2.

A Location 980 is also shown in the form of geographic positioning coordinates which will enable Data Users to more accurately determine the location of the crash event. Location 980 may also be obtained from a GPS receiver, Control Center 110 or other location determination means which is enabled by the On-board Data System 80. An example Severity 990 measurement is shown in the form of an AIS score, a standardized scoring system commonly used to measure automobile accident severity. Severity 990 measurement may be used by Data Users 150 to determine relative crash event severity or response level, and to coordinate resources, select destination facilities and prioritize activities. Severity 990 could be expressed in terms of any commonly used scoring system familiar to medical responders, including a Trauma Score, Revised Trauma Score, Injury Severity Score or AIS scores for each body region of concern.

A Driver ID 1000 is shown which may be used as a secondary identifier of a particular crash event record, and a primary identifier for medical and emergency response personnel to correlate crash event data to injured vehicle occupants. Driver ID 1000 will in most cases be transferred to Crash Data D&PS 130 from the Control Center 110 where it is stored in a Subscriber Database 210. Driver ID 1000 may also be obtained through communication with vehicle occupants or emergency responders that access driver identification information through evidence gathered from the driver's person or vehicle, in which case Driver ID 1000 may be manually entered. In some circumstances Driver ID 1000 obtained from a Control Center 110 may be overwritten by manually entered Driver ID 1000, for example when the listed driver in Subscriber Database 210 is different than the individual driving the Communication-enabled Vehicle 70 at the time of a crash event.

Vehicle 1010 identification data is shown which may be used by Data Users 150 to determine general crashworthiness of a particular vehicle involved in a crash event. Data Users 150 may use Vehicle 1010 identification data to look up external vehicle data such as historical injury data, crash testing data or vehicle design data for the identified vehicle to assess vehicle crashworthiness and crash characteristics. For example, historical injury data and crash testing data may be obtained from the Historical Injury Database 740 and Crash Test Database 750 shown in FIG. 8a, and processed in an application within the Crash Data Analysis System 500. The availability of Mechanics 1020 data is also shown, as indicating the availability status of detailed data indicative of vehicle movements during a crash event. Mechanics 1020 data may include On-board Sensor Data 1030 as well as the results of processing of On-board Sensor Data 1030 by the Crash Data Analysis System 500 or the results of analysis of On-board Sensor Data 1030 by Crash Data Experts 200. Mechanics 1020 data may be represented in Primary Event Table 920 in terms of the availability of Mechanics 1020 data or may describe the status of any processing being performed on On-board Sensor Data 1020 such as an estimated time for completion of a software application that is analyzing Mechanics 1020 data.

Analysis Data 1030 is shown which represents the availability status of crash data analyzed by the Crash Data Analysis System 500, Crash Data Experts 200 or both, such as modeling of vehicle movements during the crash event, modeling of occupant movements, predicted occupant injuries and other data analysis results. Analysis Data 1030 may be represented in the Primary Event Table 920 in terms of availability of Analysis Data 1030 or may describe the status of any processing being performed on crash event data, such as an estimated time for completion of a software application that is analyzing crash event data, estimated file size of software application results, estimated download time of software application results, or any other item of status information which a Data User 150 would like to know before deciding to examine Analysis Data 1030 in greater detail.

FIG. 14b illustrates an exemplary linkage of a Primary Event Table 920 element to an application, shown in the form of a Location 980 record which triggers an Electronic Map Display 1060 shown in FIG. 14d when Location 980 record is selected by a Pointer Device 1100. This provides Data Users 150 a visual tool for analysis of the location of a particular crash event, which may assist them in utilizing Location 980 data to estimate dispatch and transport times, possible traffic delays, and to make decisions regarding transport, destination medical facility, resource allocation, resource coordination, and other decisions regarding emergency response which may be affected by crash event location.

The Electronic Map Display 1060 is generated by the Electronic Map Display System 1070 shown in FIG. 14c, which includes a Map Engine and Display System 1090 and Geo-coded Map Data 1080. Electronic map display systems are commonly known in the art which are capable of generating an electronic map from geographic coordinates. These systems are used by vehicle communication system providers such as GM OnStar and Mercedes Tele-Aid to provide location-based services (such as driving directions), as well as internet-based providers of location services such as the MapQuest Corporation.

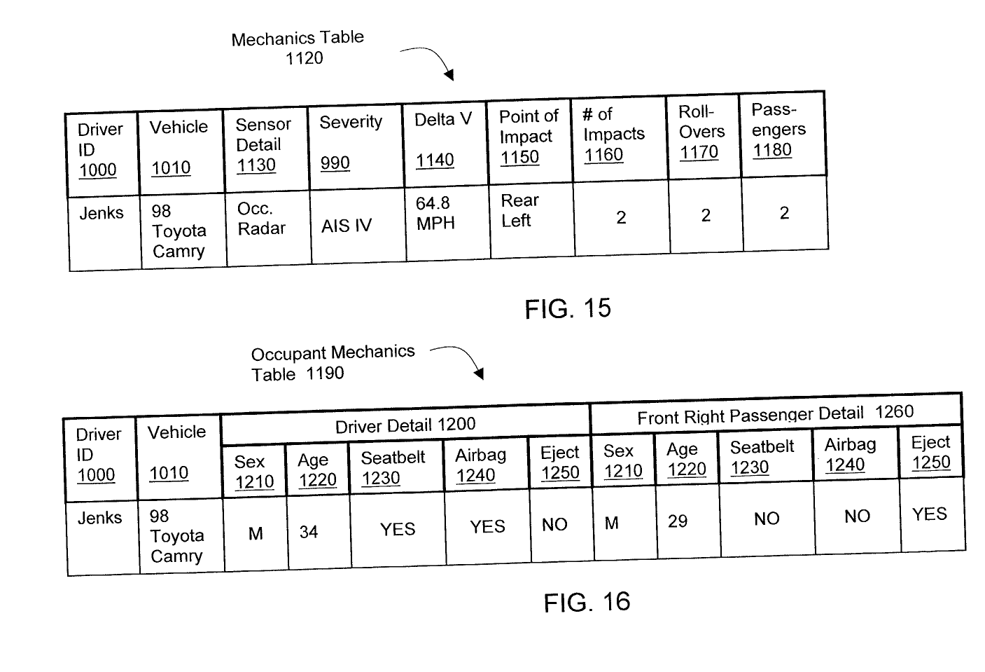

FIG. 15 illustrates an exemplary Mechanics Table 1120 that contains On-board Sensor Data 1030 and interpretation of On-board Sensor Data 1030 suggestive of vehicle movements during a crash event. Sensor Detail 1130 is shown which allows differentiation between different types of On-board Sensors 90 which may be employed by different vehicle manufacturers, including different types of sensors, different management of sensors, and any other information which may assist Data Users 150 to evaluate On-board Sensor Data 1030 in terms of accuracy, reliability, type of data, amount of data, and other factors which may be determined based on sensor type and sensor operating characteristics. Sensor Detail 1130 may include information obtained from the vehicle manufacturer, sensor developer or manufacturer, safety system developer or manufacturer, or other source which has information regarding sensor performance and operating characteristics, including an analysis of the type and reliability of On-board Sensor Data 1030 which may be obtained from a particular vehicle with particular On-board Sensors 90. Other data dlements which may be obtained from On-board Sensors 90 or determined by analysis of On-board Sensor Data 1030 by the Crash Data D&PS 130 or Crash Data Experts 200 include Delta V 1140, Point of Impact 1150, # of Impacts 1160, Rollovers 1170 and Passengers 1180 are also shown, and may be important factors that data users may utilize to infer likely occupant injuries and crash event severity.

FIG. 16 illustrates an exemplary Occupant Mechanics Table 1190 which contains data which may indicate movements of vehicle occupants during a crash event to assist Data Users 150 in determining potential injuries and injury severity of specific vehicle occupants. Data elements are segregated by occupant, such as Driver Detail 1200 and Front Right Passenger Detail 1260. Exemplary data elements are shown as including occupant Sex 1210, Age 1120, Seatbelt 1230 which indicates whether the occupant was wearing their seatbelt, Airbag 1240 which indicates whether the occupant received airbag protection during the crash, and Ejected 1250 which indicates whether the occupant was thrown from the vehicle during the crash. Occupant Mechanics Table 1190 data may be obtained from On-board Sensors 90, directly from vehicle occupants or emergency responders, or may represent the result of data analysis by a Crash Data Expert 200 or the Crash Data Analysis System 500.

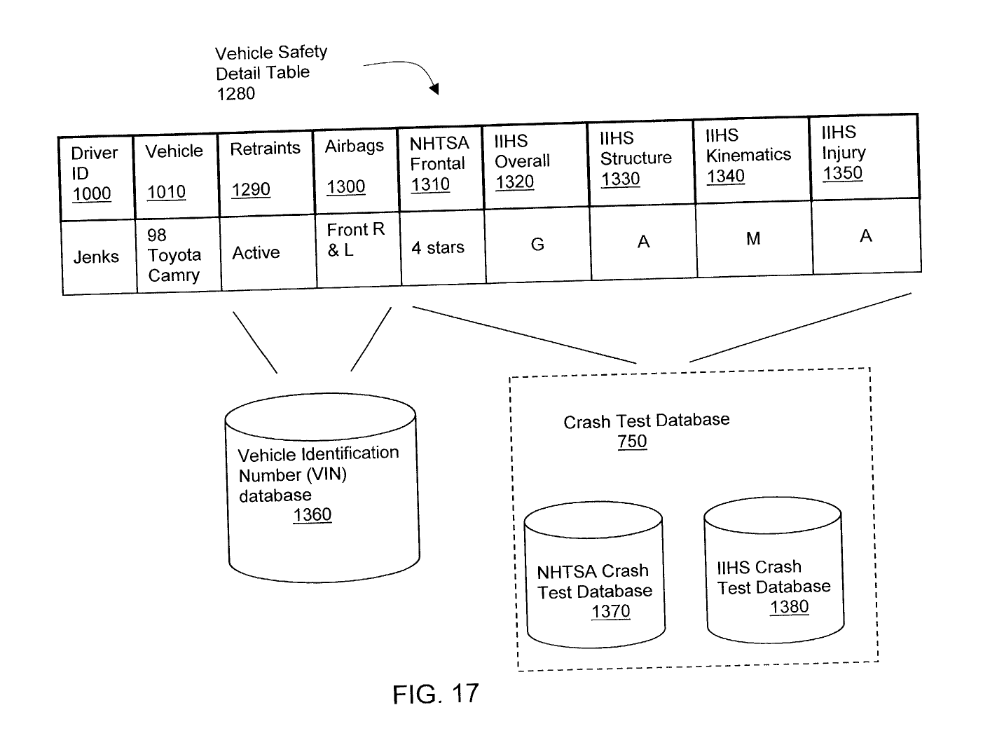

FIG. 17 illustrates an exemplary Vehicle Safety Detail Table 1280 containing specific information regarding the crashworthiness and safety features of a specific vehicle. Restraints 1290 and Airbags 1300 are shown as indicating the type of, and location of seat belt systems and inflatable restrain systems on the specific vehicle involved in the crash event. This information may be obtained by the Crash Data Management System 490 from a Vehicle Identification Number (VIN) Database 1360 as shown in FIG. 17, or may be stored as part of a Subscriber Record for a Communication System Subscriber 250 or obtained from data stored in a Safety Restraint Control System 440 or stored in a database containing information obtained from vehicle manufacturers. NHTSA 1310, IIHS Overall 1320, IIHS Structure 1330, IIHS Kinematics 1340, and IIHS Injury 1350 are all shown as results of crash testing performed on the specific vehicle involved in the crash event. This data may be retrieved by the Crash Data Management System 490 from one or more crash test databases, including the National Highway Transportation Administration (NHTSA) Crash Test Database 1370 and the Insurance Institute for Highway Safety (IIHS) Crash Test Database 1380.

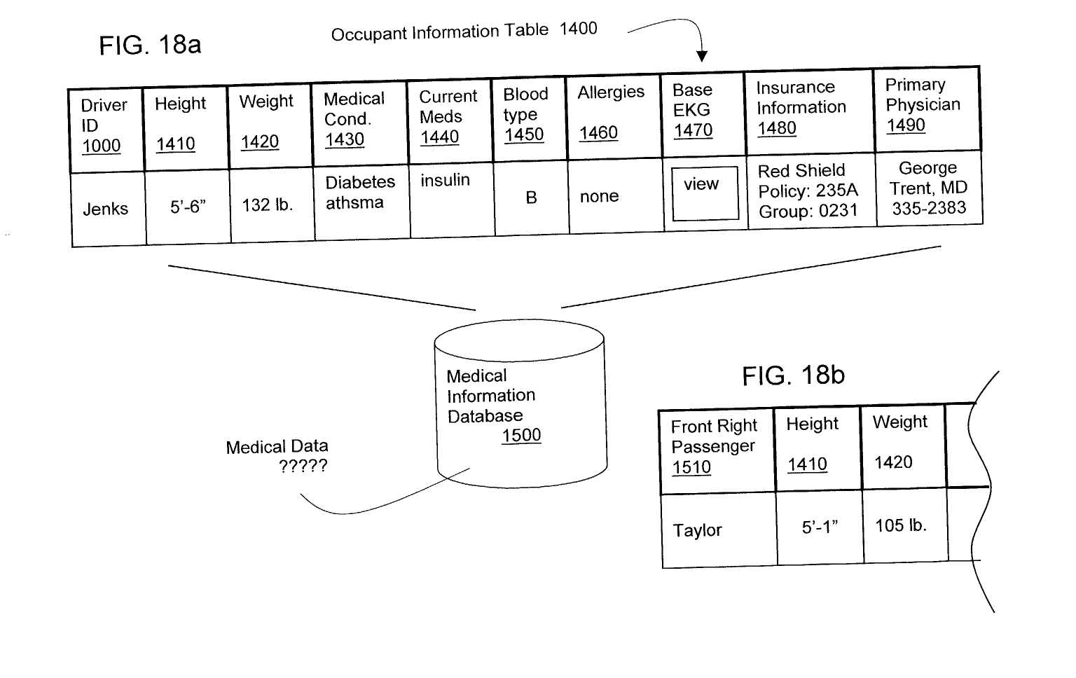

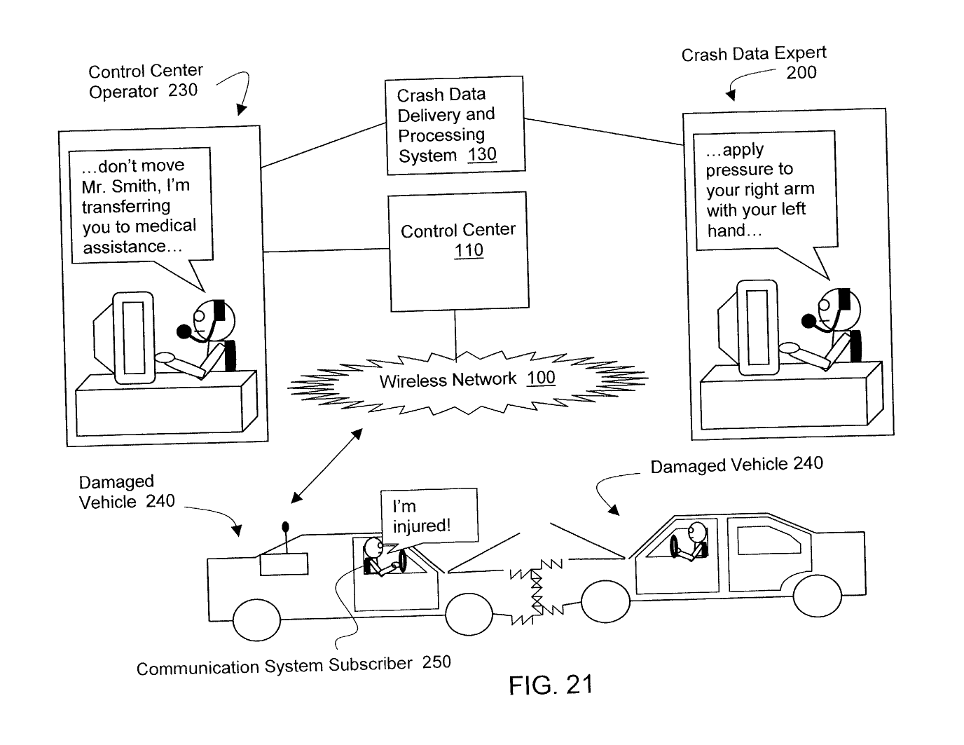

FIG. 18 illustrates an exemplary Occupant Information Table 1400 for a vehicle driver containing characteristics of a particular occupant that may impact potential injuries received during a crash event. Height 1410 and Weight 1420 are shown, and may be correlated to predicted injuries which may differ among different sized individuals subjected to the same crash forces. In addition, Height 1410 and Weight 1420 provides important input for Occupant Simulation Applications 1650 and Occupant Modeling Applications 1620 (as shown in FIG. 20). Medical Condition 1430, Current Meds 1440, Base EKG 1470 and Allergies 1460 are also shown, and may impact an individual's response to a particular crash event as well as effect the manner in which they are treated. Blood Type 1450 is shown which may effect emergency response resources, method of transport and manner of treatment based on blood type availability and other factors. Insurance Information 1480 and Primary Physician 1490 are shown which may help locate additional medical data on the injured occupant. All or part of this data may be retrieved from a Medical Information Database 1500, from information found on a vehicle occupant such as a medical information card, or directly from occupants or emergency responders (as shown in FIG. 21). Information on other occupants may also be stored as part of the crash event record, as shown in FIG. 18b for Front Right Passenger 1510.

FIG. 20 illustrates an exemplary Analysis Data Table 1520 that contains the results of analysis performed by the Crash Data Analysis System 500 or by Crash Data Experts 200. Most data categories shown may be utilized by Data Users 150 to prioritize treatments, alter diagnosis procedures, determine response levels and resources and other factors which may affect medical outcome of treatment of an injured vehicle occupant. Predictive Injury List 1530 and Expert Analysis 1540 may be generated from an application within the Crash Data Analysis System 500, or may be generated by an evaluation of the crash event data by a Crash Data Expert 1600. Crash Model 1550 represents the results of a Crash Modeling Application 1610 run on the crash event data within the Crash Data Analysis System 500. Crash Modeling Application 1610 may be an existing software application used for accident reconstruction. Occupant Model 1560 represents the results of an Occupant Modeling Application 1620 run on the crash event data within the Crash Data Analysis System 500. Occupant modeling Application 1620 may be an existing software application used for accident reconstruction that demonstrates occupant kinematics. Crash Simulation 1570 represents the results of a Crash Simulation Application 1630 which may be run from an application within the Crash Data Analysis System 500 or may represent a simulation with similar characteristics which is selected from a Crash Simulation Database 1640. Crash Simulation Applications 1630 are known to exist in the art, such as finite element programs and other programs such as PC-CRASH, ED-CRASH and ED-SMAC the latter two of which are sold by the Engineering Dynamics Corporation. Occupant Simulation 1580 represents the results of an Occupant Simulation Application 1650 which may be run from an application within the Crash Data Analysis System 500 or may represent a simulation with similar characteristics which is selected from an Occupant Simulation Database 1660. Occupant Simulation Applications 1650 are known in the art, such as rigid body programs like the Articulate Total Body (ATB) program, finite element programs such as PAM-SAFE and programs that represent hybrids between rigid body and finite element programs such as MADYMO sold by TNO Automotive.

Manual Input Data

FIG. 20a illustrates an exemplary Input Screen 1795 for the entry of Manual Input Data 1790. Manual Input Data 1790 may be manually added to crash event record in the Active Crash Event Database 640 by a Data User 150. FIG. 20a demonstrates entry of Manual Input Data 1790 through an Input Screen 1795 for data entry by an emergency medical responder of key information which may need to be added to a record or information that is preferably confirmed such as Driver ID 1800 for confirmation of driver identity, a Seat Belt 1810 for confirmation that an occupant was wearing a seat belt at the time of the crash event, Airbag 1820 for confirmation of whether an airbag inflated for the occupant, Ejected 1830 to indicate if an occupant was thrown from the vehicle, and Age 1840 to confirm the age of the occupant. Passenger 1 ID 1850 is shown, along with Seat Location 1860 to reflect the possible presence of additional occupants. An Input Individual Name 1870 and Position and Jurisdiction 1880 are also shown to identify the individual, as well as their role in emergency response, to increase the reliability of the data. Information captured by Manual Input Data 1790 will in most cases be added to Active Crash Event Database 640. A Data Input Security Access Level 1815 is shown, which represents a higher level of access security than the Base Security Access Level 642 applicable to the Active Crash Event Database 640. Manual Input Data 1790 may be utilized for other data such as post-treatment injury coding, result coding, physician and nurse notations, and other information which may be useful to compile as part of a single record, and may be added to either the Active Crash Event Database 640 or Archived Crash Event Database 650. Manual Input Data 1790 may also be given verbally by a Data User 150 to an individual in a remote location over the telephone who may then enter Manual Input Data 1790 into a crash event record. Manual Input Data 1790 may be verbally given to a Crash Data Expert 200, nurse, or other individual. An example would be an EMT at an accident scene who calls a hospital emergency department using a radio, and recites Manual Input Data 1790 to a nurse, who later enters Manual Input Data 1790 into a crash event record.

FIG. 20b illustrates several Data Users 150 that may input data into a crash event record using various methods of access to the Crash Data D&PS 130. An Emergency Medical Responder 1890 may input data through a Mobile Access Device 530 which accesses Network 140 through a Wireless Network 1 525. FIG. 20b also shows PSAP Dispatcher 1900 and a Hospital Nurse Station 1910 accessing the Crash Data D & PS through Network 140.

Occupant Triage Functions

FIG. 21 shows a Crash Data Expert 200 providing medical advice to an injured Communication System Subscriber 250 in a Damaged Vehicle 240. The communication link is shown as being a wireless voice call between the injured Communication System Subscriber 250 and a Control Center Operator 230 which is transferred to the Crash Data D&PS 130 enabling direct communication between the Crash Data Expert 200 and Communication System Subscriber 250, while the Crash Data Expert 200 is viewing crash event information. This enables Crash Data Expert 200 to assist Communication System Subscriber 250 in treating their injuries, preventing exacerbation of injuries, and in gathering additional information regarding their injuries. This additional information may then be entered into a crash event record as Manual Input Data 1790. In addition, the communication link shown in FIG. 21 may also be utilized by Data Users 150 at the scene, including paramedics and EMTs that may communicate Manual Input Data 1790 to a Control Center 110 or a Crash Data Expert 200 if the voice call has been transferred to the Crash Data D & PS 130.

Notification

There are several ways that emergency medical personnel can be notified that crash event data can be obtained for a crash event to which they are responding. One way this occurs is by a PSAP dispatcher 1900 being notified by a Control Center Operator 230. As shown in FIG. 2, Control Center Operators 230 have access to an Emergency Services Database 220 which includes contact information for PSAPs (911 dispatch call centers) that have responsibility for dispatching emergency response agencies to a crash event scene. Control Center Operators 230 are usually notified that one of their subscribers has been involved in a crash event upon receiving an automatic crash notification (ACN) signal indicating an air bag has deployed. The usual procedure followed by Control Center Operators 230 in this circumstance is to call the PSAP that covers the particular jurisdiction in which the crash event took place using the Emergency Services Database 220 that is geo-coded based on GPS coordinates. Control Center Operators 230 are able to determine the appropriate PSAP by matching up the GPS coordinates received from the On-Board Data System 80 (along with the ACN signal) using the Emergency Services Database 220. At the time Control Center Operators 230 inform the responding PSAP that a crash has occurred, they may also communicate that crash event data is available at the Crash Data D&PS 130 through Network 140. The PSAP may in turn notify emergency response agencies that crash event data is available.

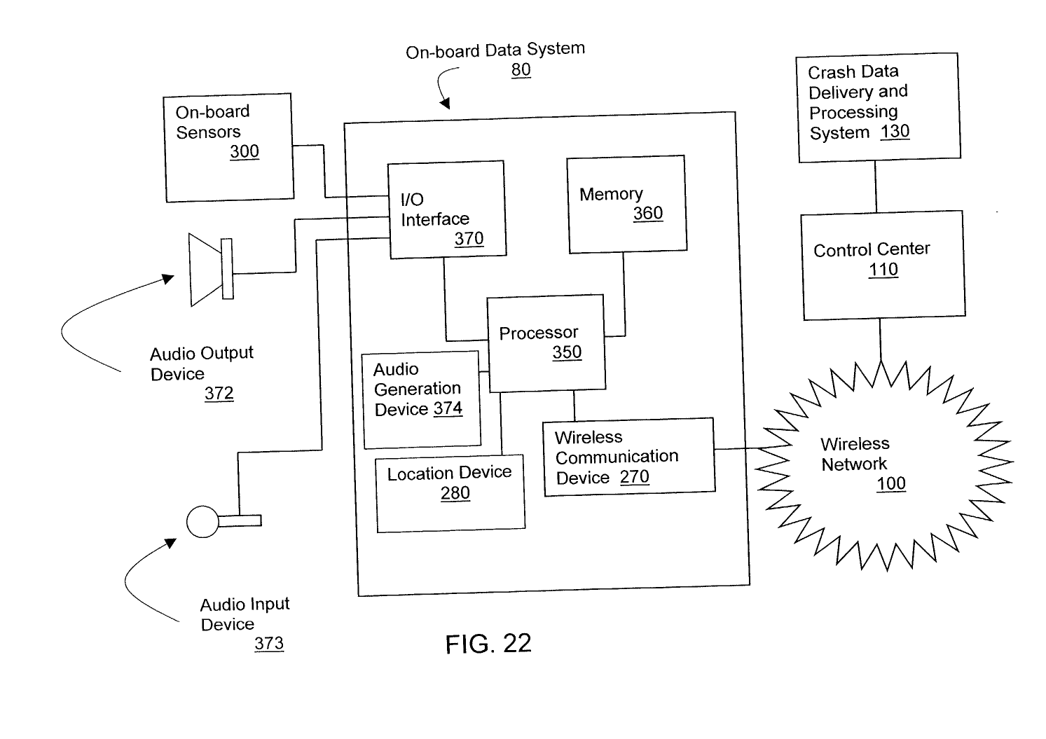

FIG. 22 illustrates an exemplary On-board Data System 80 with an Audio Output Device 372 which may be used to notify emergency response agencies that On-board Sensor Data 1030 has been transmitted from the Vehicle 70 and is available for review and analysis. On-board Data System 80 is shown in FIG. 22 as including both an Audio Output Device 372 and Audio Input Device 373, which is standard for most existing passenger vehicle On-board Data Systems 80. After a crash event has occurred, Control Center Operators 230 at Control Center 110 may monitor sound within the vehicle, and announce the availability of crash event data upon hearing sounds through Audio Input Device 373 which indicate that emergency response agencies are nearby the vehicle 70. Alternatively, operators connected to the Crash Data D&PS 130 may also monitor sound within the vehicle 70, after either having an active wireless connection with the Vehicle 70 transferred to them by Control Center 110 or by calling the On-board Data System 80 directly. Sound may be monitored through Audio Input Device 373. This process may take place while Crash Data Experts 200 are engaged in providing triage services to vehicle occupants as shown in FIG. 21. Alternatively, On-board Data System 80 may also include an Audio Generation Device 374 as shown in FIG. 22, that generates an audible announcement regarding the availability of crash event data, thereby alerting response agencies that crash event data is available. Audio Generation Device 374 may be any form of audio generation device known in the art, including a memory microchip that stores the audible announcement.

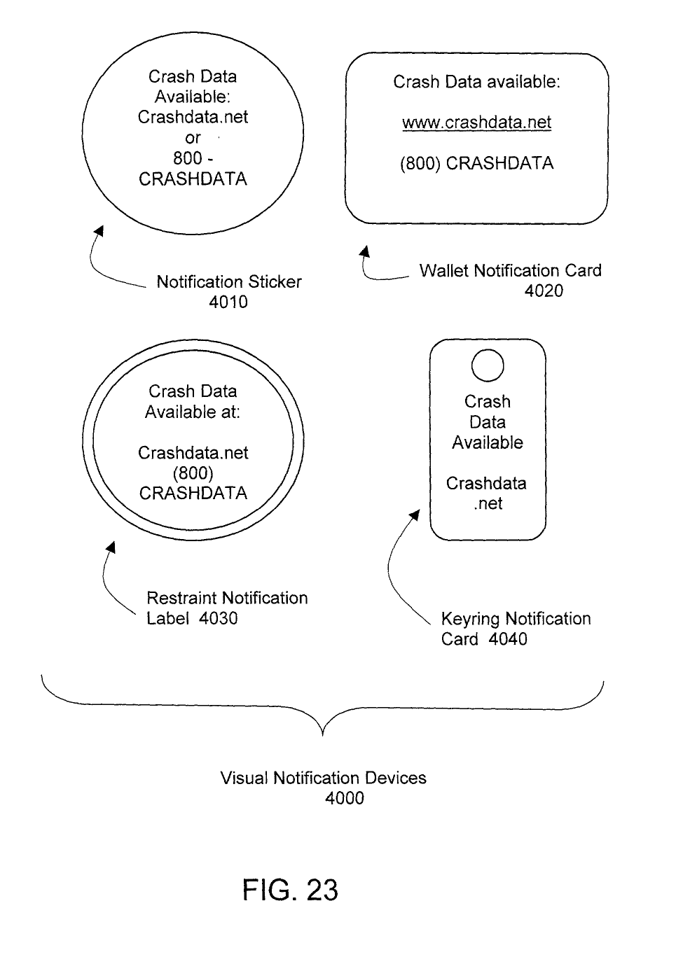

As shown in FIG. 23, Visual Notification Devices 4000 may also be employed to alert emergency response agencies that crash event data has been transmitted from a given Vehicle 70. Visual Notification Devices 4000 employ a message which indicates the crash data is available, and contains an address where more information can be obtained such as a telephone number of website address. Notification Sticker 4010 could be any type of sticker commonly used for automotive applications, including an adhesive sticker or a static-cling sticker. Notification Sticker 4010 is preferably placed with the message facing outward, in a location where emergency response agencies are likely to see it such as the inside driver's side corner of the windshield or the driver's side door window. Wallet Notification Card 4020 could be made from any type of material, and is preferably sized to fit the average wallet similar to business cards and driver's licenses. Wallet Notification Card 4020 is preferably of a distinctive color which allows Wallet Notification Card 4020 to be easily discovered by emergency response agencies which may examine an injured occupant's wallet. Restraint Notification Label 4030 is preferably a sewn or printed label which is securely fastened to an emergency restraint device inside the Vehicle 70, including an air bag, seat belt, seat belt latch or crash-activated window curtain. Keyring Notification Card 4040 is preferably a moisture-protected card with a punched hole for placement on a key ring. Keyring Notification Card 4040 is preferably of a distinctive color to assist emergency response agencies with discovery of Keyring Notification Card 4040 when assisting an injured vehicle occupant.

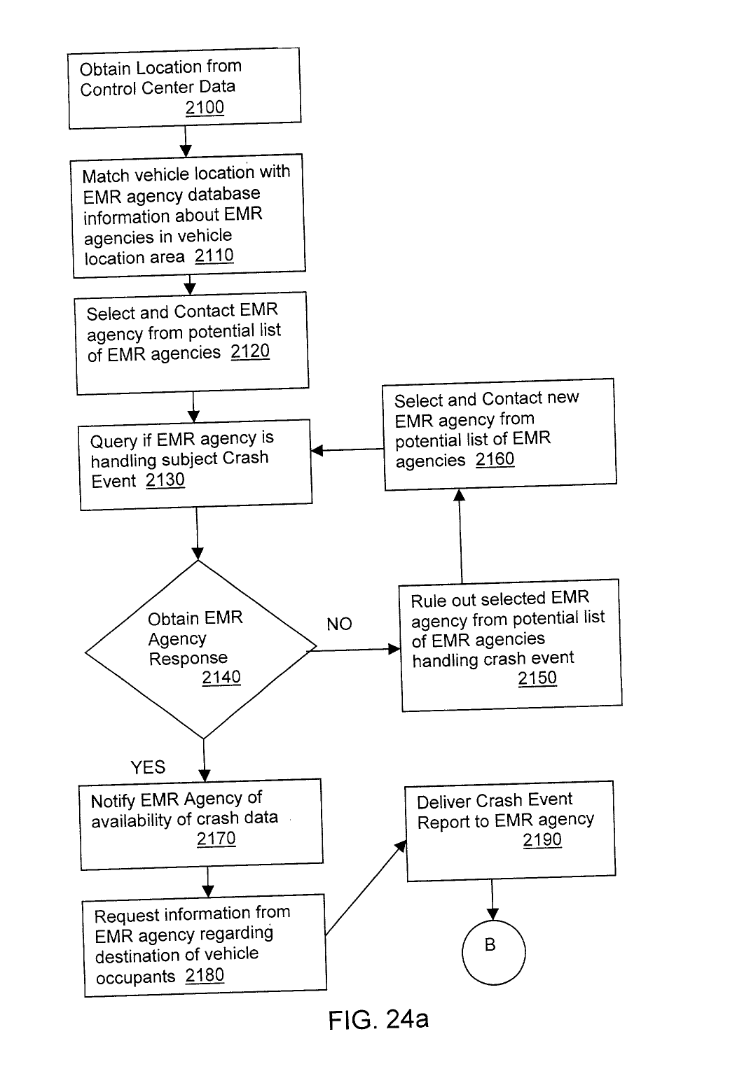

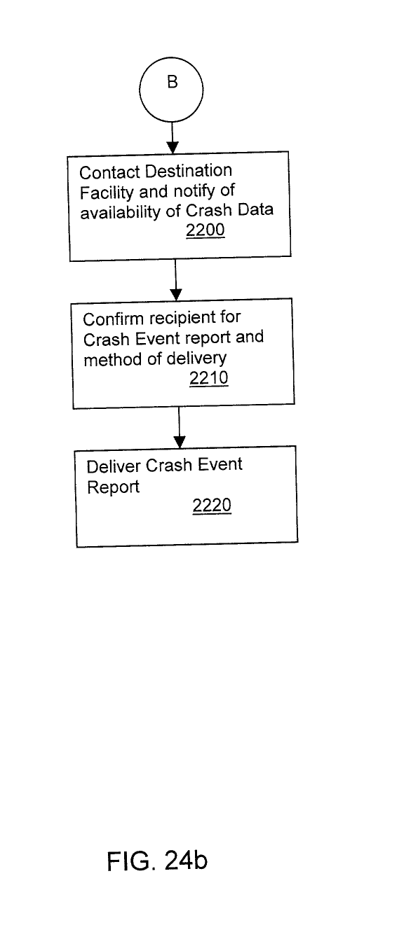

As shown in FIGS. 10a, 10b, 10c, Crash Data D&PS 130 also includes databases for emergency services. These databases may be utilized to track down emergency medical responders responding to a particular crash event, and notify them of the existence of crash event data or provide them a Crash Event Report 2425. FIG. 24a illustrates a method for actively determining the identity of an Emergency Medical Response (EMR) agency which is responding to a particular crash event, as well as the destination medical facility of the injured vehicle occupants and delivering Crash Event Data relevant to the crash event. The location of the crash event is first obtained from the Control Center 110 responsive to the vehicle communications system in the subject vehicle 2100, the location information may include the Public Safety Answering Point which has jurisdiction over the crash event location. The vehicle location is matched with EMR agency database, which may contain geographically coded PSAP information as well as geographically coded information about paramedic, Emergency Medical Technician (EMT), Fire Department and other potential EMR agencies that may respond to an accident scene 2110. The most likely EMR agency is selected from the potential list of EMR agencies in the crash event area which may be responding to the crash event, and contact is attempted with the EMR agency 2120. The EMR agency is queried regarding their involvement in responding to the subject crash event 2130, 2140. If the chosen EMR agency is not responding to the event, they are ruled out 2150 and another EMR agency is selected from the potential list of EMR agencies in the crash event area 2160. If the EMR agency is responding to the crash event, they are notified of the availability of crash event information 2170 and they are queried regarding the destination medical facility of injured vehicle occupants 2180. Crash event information is then delivered to the EMR agency 2190 based on their delivery mechanism of choice 2190 and the destination medical facility is contacted and notified of the availability of crash event data 2200 as shown in FIG. 24b. The mechanism of information delivery, address and recipient is confirmed with the destination medical facility 2210 and the crash data is delivered 2220.

Additional Data Use Methods

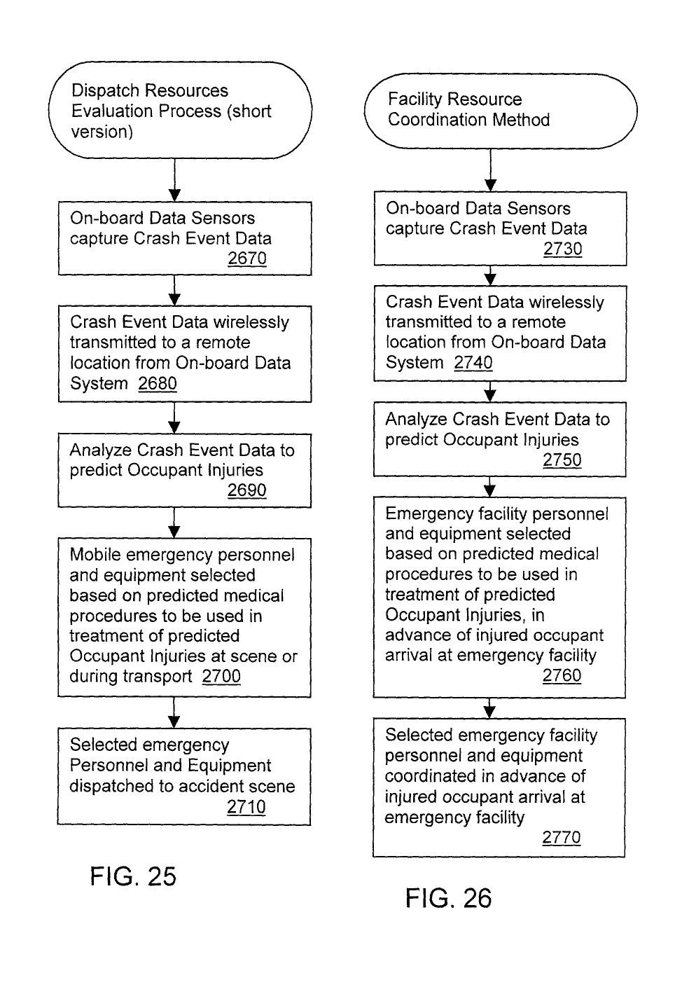

In addition to the above-disclosed methods and process for using the Crash Data D&PS 130 as a decision-aid system for medical, FIGS. 25 through 34 show additional specific uses of the disclosed decision-aid system.

FIG. 25 is a flowchart illustrating a process for evaluating the emergency response resources that need to be dispatched to the scene of a crash event utilizing On-board Sensor Data 1030. First, crash data is captured 2670 by Onboard Sensors 90. Second, crash data is transmitted 2680 by an On-board Data System 80 that wirelessly transmits data to a remote location. Third, crash data is analyzed 2690 to predict crash severity and potential occupant injuries. Fourth, emergency response resources are selected 2700, such as personnel and equipment, based on crash data. Fifth, emergency response resources are dispatched 2710 to the crash scene.

FIG. 26 is a flowchart illustrating a process for coordinating trauma resources at a medical facility utilizing On-board Sensor Data 1030. First, crash data is captured 2730 by On-board Sensors 90. Second, crash data is transmitted 2740 by an On-board Data System 80 that wirelessly transmits data to a remote location. Third, crash data is analyzed 2750 to predict crash severity and potential occupant injuries. Fourth, medical facility resources are selected 2760, such as surgeons, nurses, diagnostic personnel, anesthesiologists, diagnostic equipment, operating rooms and other emergency medical equipment and personnel based on crash data. Fifth, medical facility resources are coordinated 2770 in advance of injured occupant arrival at medical facility.

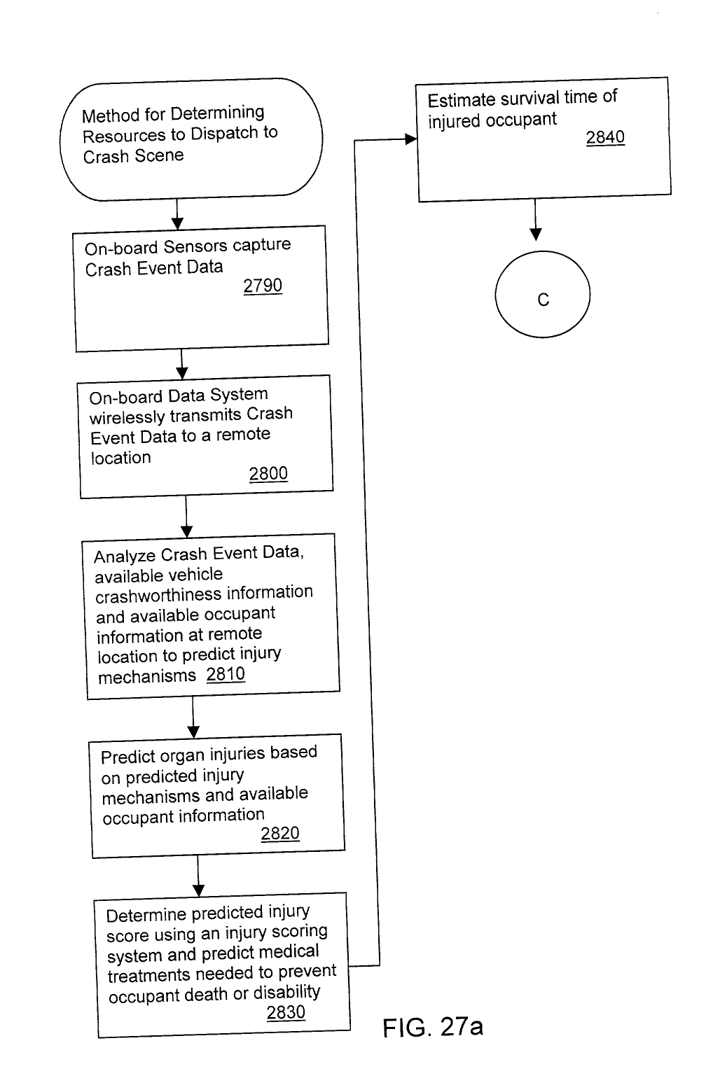

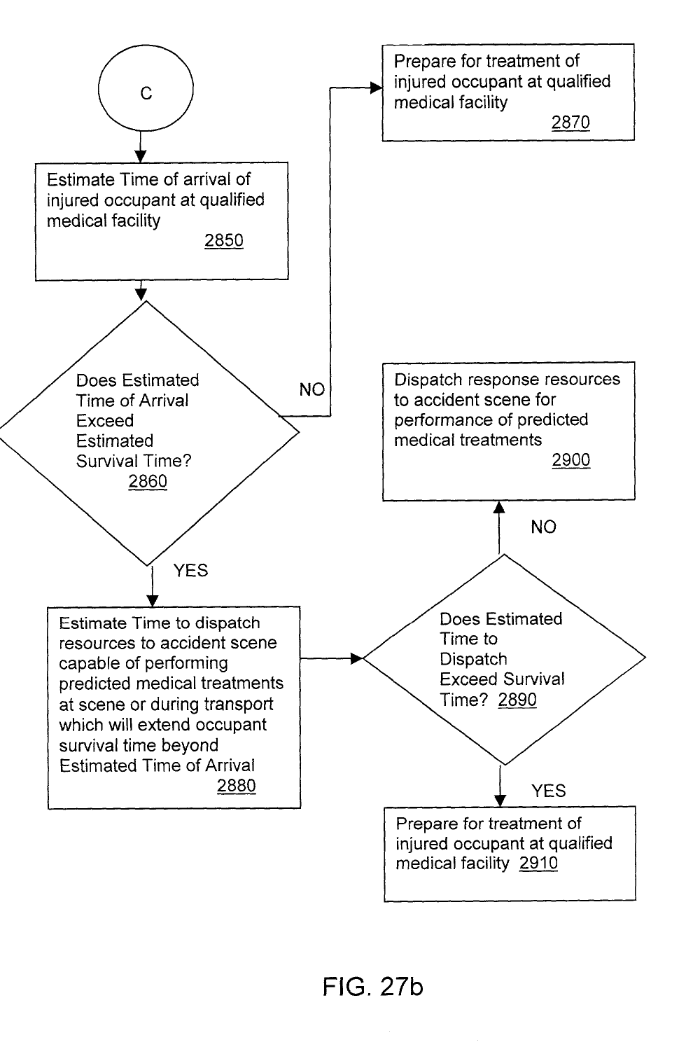

FIGS. 27a and 27b are a flowchart representing a process for determining whether advanced life support equipment and personnel should be dispatched to a crash event scene for performance of potentially lifesaving medical treatment which, in the absence of crash event data, would otherwise be rendered at a medical facility. First, crash data is captured 2790 by On-board Sensors 90. Second, crash data is transmitted 2800 by an On-board Data System 80 that wirelessly transmits data to a remote location. Third, crash data is analyzed 2810 to predict crash severity and potential occupant injuries. Fourth, organ injuries are predicted 2820 based on crash data. Fifth, organ injury severity is scored 2830 using an injury scoring system and probability of injuries requiring potentially lifesaving medical treatment is determined. Sixth, survival time without potentially lifesaving medical treatment is estimated 2840 for injured vehicle occupant. Seventh, time of treatment is estimated 2850 for potentially lifesaving medical treatment to be administered at a medical facility for injured occupant. Eighth, estimated survival time is compared to estimated time of treatment 2860. Nine, a decision is made to administer potentially lifesaving medical treatment at a medical facility 2870 or to consider administering potentially lifesaving medical treatment at scene or during transport 2880. Ten, estimated survival time is compared to estimated time of administration of potential lifesaving medical treatment at the crash scene or during transport 2890. Eleven, a decision is made whether resources should be dispatched to the crash scene capable of administering potentially lifesaving medical treatment 2900 or whether the injured occupant should be transported to a medical facility 2910 for potentially lifesaving medical treatment.

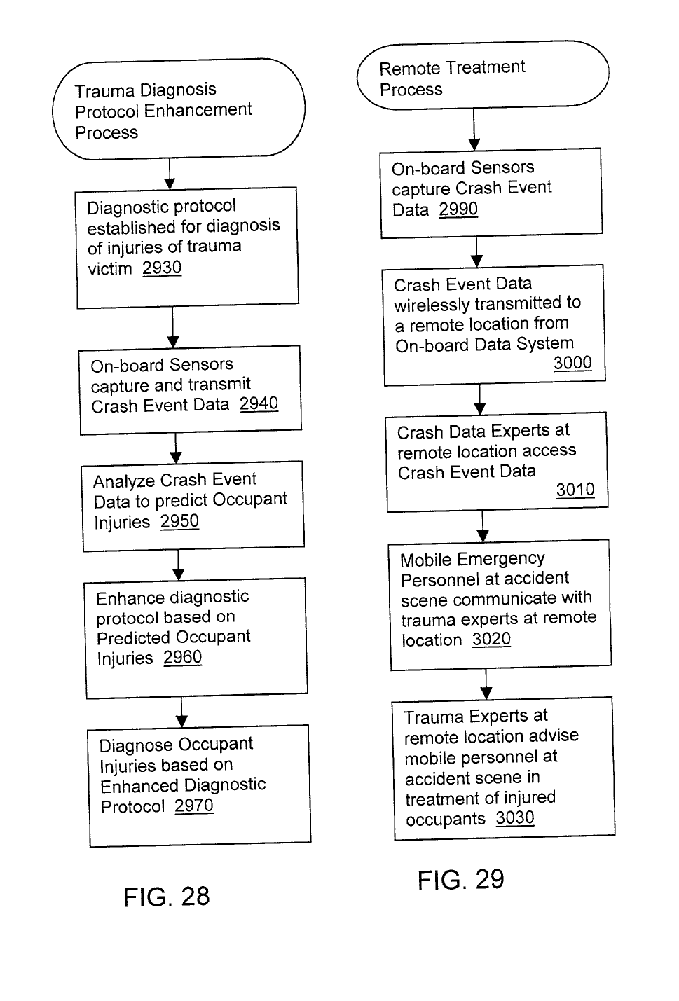

FIG. 28 is a flowchart illustrating a process for modifying a trauma diagnosis protocol based on crash event data. First, a diagnosis protocol is established 2930 for diagnosis of the injuries of a vehicle occupant injured in a crash. Second, crash data is captured 2940 by On-board Sensors 90. Third, crash data is transmitted 2945 by an On-board Data System 80 that wirelessly transmits data to a remote location. Fourth, crash data is analyzed 2950, which may include prediction of crash severity and potential occupant injuries. Fifth, the diagnosis protocol is revised 2960 based on analyzed crash data. Sixth, an injured occupant is diagnosed 2970 based on the revised diagnosis protocol.

FIG. 29 is a flowchart illustrating a process for remotely treating an injured vehicle occupant using crash event data. First, On-board Sensor Data 1030 is captured 2990 by On-board Sensors 90. Second, On-board Sensor Data 1030 is transmitted 3000 by an On-board Data System 80 that wirelessly transmits data to a remote location. Third, crash event data is accessed 3010 by Crash Data Experts 200 at a remote location. Fourth, communication is established 3020 between Crash Data Experts 200 and emergency personnel responding to the crash event. Fifth, Crash Data Experts 200 assist 3030 emergency personnel with the treatment and handling of injured occupants based on crash event data.

FIG. 30 is a flowchart illustrating a process for determining the survival probability of an injured vehicle occupant using crash event data. First, On-board Sensor Data 1030 is captured 3050 by On-board Sensors 90. Second, On-board Sensor Data 1030 is transmitted 3060 by an On-board Data System 80 that wirelessly transmits data to a remote location. Third, crash event data is analyzed 3070 to predict injury mechanisms. Fourth, organ injuries are predicted 3080 based on predicted injury mechanisms. Fifth, an injury score is generated 3090 using an injury scoring method. Sixth, an injury severity score is generated 3100 if multiple severe injuries are predicted. Seventh, a coma score is generated 3110 based on eye, verbal and motor responses of injured occupant. Eighth, a revised trauma score is generated 3120 based on coma score, blood pressure and respiratory rate of injured occupant. Ninth, survival probability is determined 3130 based on revised trauma score, injury severity score, patient age and comparison of these factors to historical trauma outcomes.

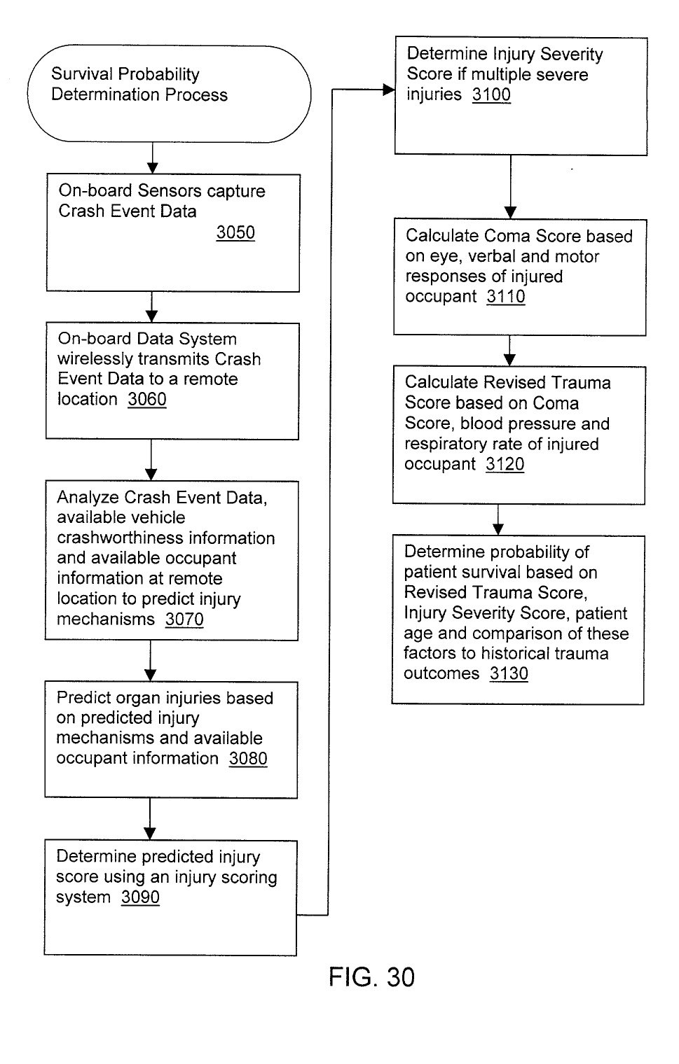

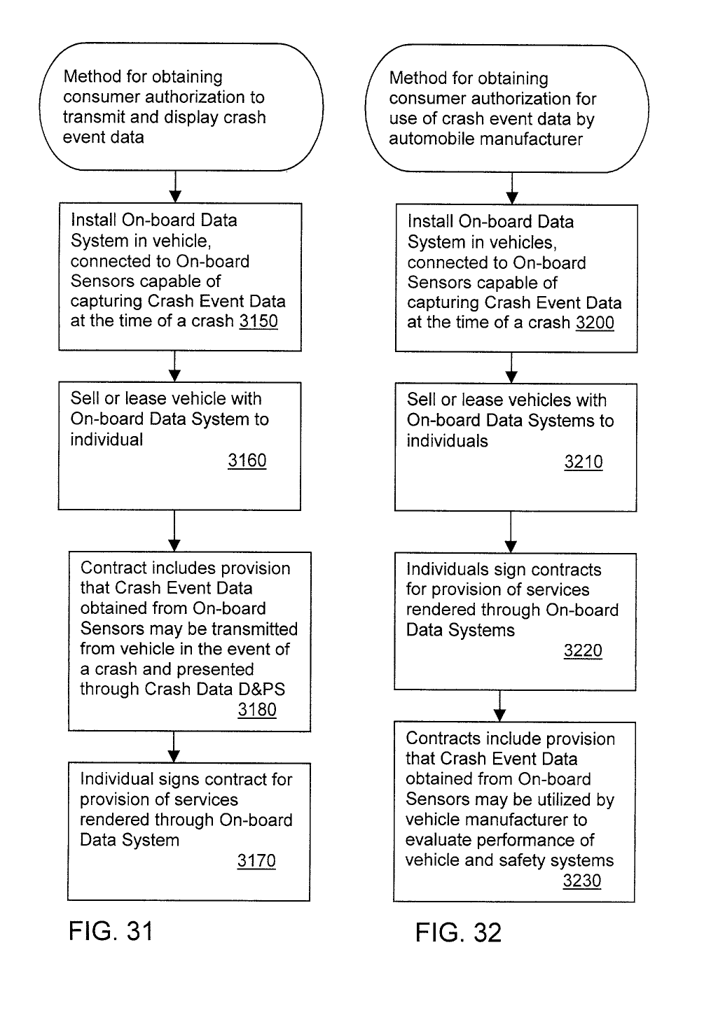

FIG. 31 is a flowchart illustrating a process for obtaining consumer authorization to transmit and display crash event data. First, an On-board Data System 80 is installed 3150 into a vehicle. Second, the vehicle is sold or leased 3160. Third, an individual who purchased or leased the vehicle is presented a contract for provision of services utilizing the On-board Data System 80 which contains a provision stating that the individual authorizes data obtained from the On-board Sensors 90 may be wirelessly transmitted by the On-board Data System 80 in the event of a crash, and may be presented 3180 through a Crash Data D&PS 130. Fourth, the individual signs the contract 3170.

FIG. 32 is a flowchart illustrating a process for authorizing use of crash event data by the manufacturer of the vehicle. First, an On-board Data System 80 is installed 3200 into a vehicle. Second, the vehicle is sold or leased 3210. Third, an individual who purchased or leased the vehicle is presented a contract for provision of services utilizing the On-board Data System 80 which contains a provision stating that the individual authorizes data obtained from the On-board Sensors 90 may be wirelessly transmitted by the On-board Data System 80 in the event of a crash, and may be used by the vehicle manufacturer for evaluation of the performance of vehicle safety systems 3230. Fourth, the individual signs the contract 3220.

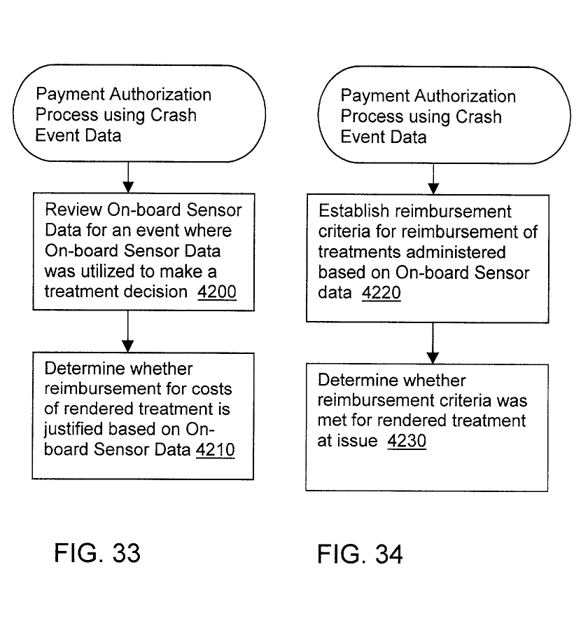

FIG. 33 is a flowchart illustrating a process for authorizing reimbursement to a medical provider for services rendered to an injured vehicle occupant based on crash event data. FIG. 34 is a flowchart illustrating a process for authorizing reimbursement to a medical provider for services rendered to an injured vehicle occupant based on crash event data, using pre-established criteria regarding the sufficiency and accuracy of crash event data.

Although the invention has been described and illustrated in detail, it is to be understood that the detail provided is by way of example and illustration, is not to be considered a limitation, and that modifications and changes therein may be made by those skilled in the art without departing from the spirit and scope of the invention. Accordingly, the scope of this invention is to be limited only by the appended claims.

We claim:

1. A method for transmitting from a vehicle to a remote location on-board sensor data associated with a crash event, the vehicle including a safety restraint control system and an on-board data system that is capable of transmitting crash event data to the remote location, the method comprising:
receiving on-board sensor data with the safety restraint control system from at least one on-board sensor; and
storing the on-board sensor data; and
transferring the on-board sensor data from the safety restraint control system to the on-board data system when the safety restraint control system detects a crash event.

2. The method of claim 1 wherein the receiving step comprises:
receiving on-board sensor data for a predetermined period of time after detecting the crash event and before transmitting the on-board sensor data to the remote location.

3. A method for transmitting from a vehicle to a remote location onboard sensor data associated with a crash event, the vehicle including a safety restraint control system and an on-board data system that is capable of transmitting crash event data to the remote location, the method comprising:
receiving on-board sensor data by the safety restraint control system from at least one on-board sensor; and
storing the on-board sensor data;
detecting a crash event;
transferring the on-board sensor data from the safety restraint control system to the on-board data system; and
transmitting the on-board sensor data from the on-board data system to a remote location.

4. The method of claim 3 wherein the transferring step comprises:
transferring the on-board sensor data to the on-board data system through a vehicle data bus.

5. The method of claim 4 further comprising:
completing a communication circuit between the safety restraint control system and the vehicle data bus when the crash-event is detected.

6. The method of claim 5 wherein the transmitting step comprises:
transmitting the on-board sensor data wherein the on-board sensor data includes data that is indicative of potential injuries sustained by vehicle occupants.

7. A method for transmitting crash event information from a vehicle to a remote location, comprising the steps of:
monitoring at least one on-board sensor capable of providing data during a crash event that has a predetermined relationship to potential occupant injuries; and

8. A method for maintaining a crash event database, the crash event database including subscriber data which includes personal data and vehicle data, the method comprising:
receiving crash-event data from a vehicle when the vehicle experiences a crash event, the crash event data including on-board sensor data associated with the crash event and a vehicle identifier;
reading the vehicle identifier; and
correlating the crash event data with subscriber data corresponding to the vehicle identifier.

9. A method for predicting potential injuries to occupants in a vehicle resulting from a crash event, the method comprising:
receiving crash event data, the crash event data including on-board sensor data associated with a crash event of a vehicle with occupants;
analyzing the crash event data;
determining potential injuries to the occupants;
communicating the potential injuries to medical personnel.

10. A system for managing crash events, the system comprising:
a computer system configured to:
receive crash event data, the crash event data including on-board sensor data associated with a crash event of a vehicle with occupants; and
display the crash event data to an operator;
a communication system for communicating a crash event report to an emergency service providers (ESP).

11. A system for managing crash events as claimed in claim 10 wherein the computer system is configured to receive a crash event report indicative of potential injuries to the occupants from the operator.

12. A system for managing crash events as claimed in claim 10 wherein the communication system includes a network connected to the compute system for transmitting the crash event report to the ESP.

13. A system for managing crash events as claimed in claim 10 wherein the communication system includes a telephone system.

14. A system for managing crash events as claimed in claim 10, wherein the communication system communicates the crash-event report to ESPs having a likelihood for responding to the crash event.

15. A system for managing crash events as claimed in claim 10 further comprising a database of emergency services providers.

16. A system for managing crash events as claimed in claim 10 wherein the computer system includes an operator input and a graphics display.

17. A system for managing crash events as claimed in claim 10 wherein the communication system includes a wireless network configured to allow trauma personnel to access the computer system.

18. A method for notifying trauma personnel about a crash event of a vehicle with occupants, the method comprising:
maintaining a trauma personnel database including . . .
receiving crash event data including location data;
looking up in the database trauma personnel corresponding to the location data; and
notifying the trauma personnel of the crash event.

19. A method for notifying trauma personnel about a crash event of a vehicle with occupants as claimed in claim 18, wherein the maintaining step comprises:
receiving from a trauma person, emergency response information including a predetermined response boundary;
storing the emergency response information in a database;

20. A method for notifying trauma personnel about a crash event of a vehicle with occupants as claimed in claim 19, wherein the maintaining step further comprises:
receiving communication information from the trauma person.

21. A method for notifying trauma personnel about a crash event of a vehicle with occupants as claimed in claim 18, wherein the notifying step comprises
notifying the trauma personnel of a crash-event report.

22. A method for notifying trauma personnel about a crash event of a vehicle with occupants as claimed in claim 21, wherein the maintaining step comprises;
configuring the database into relevant geographic areas.

23. A method for notifying trauma personnel about a crash event of a vehicle with occupants as claimed in claim 18, wherein the notifying step comprises the step of:
notifying a trauma person if a crash event criteria required exceeds a predetermined threshold.

24. A method for remotely accessing crash event data associated with a crash event of a vehicle with occupants, the method comprising:
receiving notification associated with a crash event; and
accessing a wireless network to retrieve crash event data associated with the crash event.

25. A method for remotely accessing crash event data associated with a crash event of a vehicle with occupants as claimed in claim 24, wherein the receiving step comprises:
visually accessing information from the vehicle.

26. A method for remotely accessing crash event data associated with a crash event of a vehicle with occupants as claimed in claim 24, wherein the receiving step comprises:
receiving a crash event report.

27. A method for remotely accessing crash event data associated with a crash event of a vehicle with occupants as claimed in claim 24, wherein the receiving step includes:
receiving the crash event report on a portable electronic device.

28. A method for managing the crash event data of drivers of vehicles who have subscribed to an automotive service, the crash event data including subscriber data and on-board sensor data, the subscriber data including personal data and vehicle data, the on-board sensor data including vehicle movement sensors and occupant sensors, the method comprising:
receiving on-board sensor data associated with one of the drivers;
analyzing the on-board sensor data;
communicating the on-board sensor data to a trauma services provider.

29. The method of claim 28 wherein the trauma services provider includes a trauma center.

30. The method of claim 28 wherein the subscriber data includes the gender of the subscriber, and the gender is used in the step of analyzing the on-board sensor data.

31. The method of claim 28 wherein the subscriber data includes the age of the subscriber, and the age is used in the step of analyzing the on-board sensor data.

32. The method of claim 28 wherein the subscriber data includes medical data about the subscriber, and the medical data is used in the step of analyzing the on-board sensor data.

33. A method for assisting a driver of a vehicle who has subscribed to an automotive service in obtaining medical care after a vehicle accident, the driver having user data including subscriber data and on-board sensor data, the subscriber data including personal data and vehicle data, the on-board sensor data including data generated by vehicle movement sensors and occupant sensors when the vehicle is in a crash event, the method comprising:
receiving authorization from a driver to receive the crash event data;
receiving crash event data from the vehicle when a crash event occurs; and
communicating the crash event data to medical personnel.

34. The method in claim 33 wherein the step of receiving authorization comprises receiving a signed document from the driver.

35. The method in claim 33 further comprising:
analyzing the crash event data before communicating the crash event data to medical personnel.

36. The method of claim 33 further comprising:
communicating the crash event data to a third party.

37. A method for obtaining crash event data from a vehicle with a driver to assess performance of a safety system in the vehicle in a crash event, the driver of the vehicle having subscribed to an automotive service in obtaining medical care when a crash event occurs, the driver having user data including subscriber data and on-board sensor data, the subscriber data including personal data and vehicle data, the on-board sensor data including data generated by vehicle movement sensors and occupant sensors when the vehicle is in a crash event, the method comprising:
receiving authorization from a driver to receive the crash event data;
receiving crash event data from the vehicle when a crash event occurs; and
communicating the crash event data to a third party.

38. A method for analyzing crash event data, the method comprising:
receiving crash event data;
comparing the crash event data to a database containing crash event data from other crash events;

39. A system for predicting trauma injuries to an occupant of a vehicle resulting from a crash event, the system comprising:
a computer with a memory configured to automatically receive crash event data associated with a crash event, the crash event data including on-board sensor data;
a database in communication with the computer, the database including a set of historical accident records that include injury mechanism data and sustained injuries;
means for comparing the injury mechanism data for the crash event to the injury mechanism data in the set of historical accident records;
means for generating a list of potential injuries including the sustained injuries from each of the historical accident records in the database in which the injury mechanism data substantially matches the injury mechanism data for the crash event; and
means for displaying the list of potential injuries.

40. The system of claim 39 further comprising means for determining the statistical likelihood of each of the sustained injuries included in the list of potential injuries.

41. The system of claim 39 wherein the database is supplemented by manual input data.

42. The system of claim 39 wherein the displaying means includes a video monitor.

43. The system of claim 39 wherein the displaying means includes a printer.

44. The system of claim 39 wherein the historical accident records include on-board sensor data.

45. The system of claim 44 wherein the on-board sensor data includes data obtained from vehicle movement sensors and occupant sensors.

46. The system of claim 39 wherein the historical accident records includes FARS/MCOD data.

47. An expert system for predicting trauma injuries resulting from a crash event of a vehicle, the system comprising:
a database including:
a knowledge base having rules relating injury mechanism information to potential occupant injuries;
expert system input data containing information about the crash event;
a computer in communication with the database for executing an inference engine-for generating a list of potential occupant injuries based on applying the rules to the expert system input data.

48. The expert system of claim 47 wherein the computer executes an application program for displaying the list of potential occupant injuries.

49. The expert system of claim 47 the computer calculates the statistical probability of each potential occupant injury on the list with the inference engine.

50. The expert system of claim 47 wherein the inference engine provides information for the basis of the list.

51. A data processing system for analyzing crash event data of a vehicle, the crash event data including a crash pulse, the system comprising:
(a) computer processor means for processing data;
(b) storage means for storing data on a storage medium;
(c) first means for processing data regarding the crash pulse recorded by the vehicle;
(d) second means for processing data regarding the crashworthiness of the vehicle.

52. The data processing system in claim 51, including a third means for processing data regarding a principal direction of force recorded by the vehicle during the crash event.

53. The data processing system in claim 51, including a fourth means for processing data regarding a vehicle restraint system recorded by the vehicle during the crash event.

54. The data processing system in claim 51, including a fifth means for processing data regarding the occupant position within the vehicle cabin recorded by a vehicle during a crash event.

55. The data processing system in claim 51, including a sixth means for processing data regarding occupant characteristics.

56. A method for evaluating a patient with injuries resulting from a crash event of a vehicle, the vehicle generating crash event data when the crash event occurs, the method comprising:
receiving information based on crash event data;
evaluating the patient to determine potential injuries; and
accessing the crash event data to confirm the potential injuries.
